(19) United States
(12) Patent Application Publication
(10) Pub. No.: US 2026/0017548 A1
(43) Pub. Date: Jan. 15, 2026

(54) Multi Level Quantum Based Vertically Classified Entropy Exploratory Analytics Tool

(71) Applicant: Bank of America Corporation, Charlotte, NC (US)

(72) Inventors: Rajesh Narayanan, Chennai (IN); Manu Kurian, Dallas, TX (US); Jabir Mahammad, Hyderabad (IN)

(21) Appl. No.: 18/768,210

(22) Filed: Jul. 10, 2024

(51) Int. Cl. G06N 10/20; G06N 10/60

(52) U.S. Cl. CPC G06N 10/20; G06N 10/60

(57) ABSTRACT

Systems and processes are disclosed for a multi-level quantum-based vertically classified entropy exploratory analytics tool designed to improve speed, accuracy, and scalability in anomaly detection and data analysis. The tool employs a dynamic algorithm selector for adaptive algorithm choice, a quantum encoder for precise data encoding, and a multi-level splitter and aggregator for efficient data segmentation and result integration. It includes a classification executor for accurate decision-making, an exploratory data analyzer for uncovering hidden patterns, and a multi-dimensional data processor for handling complex data sets. A qubit selector optimizes quantum resource allocation. The tool combines classical and quantum computing methods, enhancing robustness and versatility. This system significantly reduces false positive rates and improves processing efficiency, addressing the limitations of classical methods in handling large-scale, multi-dimensional data sets. The invention is particularly valuable for applications requiring rapid and precise data analysis, such as finance, cybersecurity, and scientific research.

### TECHNICAL FIELD

The invention relates to data processing systems and methods employing artificial intelligence techniques. Specifically, the invention pertains to the use of quantum computing for anomaly detection and entropy exploratory analysis in multi-dimensional data sets. It addresses the limitations of classical computing methods by leveraging the significant advantages of quantum computing, such as speed, simultaneous execution, accuracy, and scalability. The invention employs a multi-level quantum-based vertically classified exploratory analysis technique, utilizing dynamic and combined algorithm selection across different stages of execution with varied qubits. The key components include a quantum encoder, dynamic algorithm selector, multi-level splitter and aggregator, qubit selector, classification executor, exploratory data analyzer, and multi-dimensional data processor. By integrating these components, the invention enhances the capability to process massive volumes of data, improve the accuracy of anomaly detection, and support simultaneous execution of various algorithms. This technical approach positions the invention within the field of data processing systems that utilize artificial intelligence techniques to achieve higher speed, precision, and efficiency in analyzing and interpreting complex data sets.

### DESCRIPTION OF THE RELATED ART

In short, the classical computing methods used for entropy exploratory analysis and anomaly detection suffer from limitations in speed, accuracy, and scalability, especially when processing large volumes of data. These methods require substantial memory and storage, and their sequential algorithm execution is inadequate for modern data needs, particularly when dealing with multi-dimensional data sets. Additionally, classical methods struggle with high false positive rates in anomaly detection and lack the flexibility for dynamic algorithm selection and execution. These inefficiencies lead to delayed execution times, increased computational costs, and incomplete or inaccurate data analysis.

More specifically, the problems addressed by this invention revolves around the limitations and inefficiencies inherent in classical computing methods for entropy exploratory analysis and anomaly detection. Classical computing, despite its advancements, struggles with speed, accuracy, and scalability when processing large volumes of data. This is particularly problematic in fields requiring rapid and precise data analysis, such as finance, cybersecurity, and scientific research. The existing methods require substantial memory and storage, as well as significant execution power, which hampers their efficiency and effectiveness. As data volumes continue to grow exponentially, these limitations become more pronounced, leading to delayed execution times and increased computational costs.

Classical computing methods are typically restricted to one- or two-dimensional data analysis and can only execute algorithms in a sequential manner. This sequential processing significantly limits the speed and efficiency of data analysis, especially when dealing with multi-dimensional data sets. The inability to perform simultaneous data analysis and dynamic algorithm selection further exacerbates the problem, resulting in slower detection of anomalies and increased false positive rates. The complexity of modern data sets necessitates a more robust and scalable solution that classical computing struggles to provide.

Another critical issue with classical computing methods is their high false positive rates in anomaly detection. These methods often fail to accurately distinguish between normal and anomalous behavior, leading to frequent false alarms. This not only reduces the efficiency of anomaly detection systems but also erodes trust in their accuracy. Businesses and organizations relying on these systems for critical decision-making processes find themselves overwhelmed by false positives, which require additional resources to investigate and verify. This inefficiency can lead to missed genuine anomalies and increased vulnerability to threats.

The problem extends to the difficulty in handling multi-dimensional data analysis using classical methods. Modern data sets are increasingly complex, involving multiple dimensions that need to be analyzed simultaneously to uncover meaningful patterns and anomalies. Classical computing methods, with their sequential processing capabilities, are ill-suited for this task. They are often unable to capture the intricate relationships within multi-dimensional data, resulting in incomplete or inaccurate analysis. This limitation hampers the ability to gain valuable insights from the data, impeding decision-making processes and strategic planning.

Furthermore, classical computing methods are not flexible enough to support dynamic algorithm selection and execution. In a rapidly evolving data landscape, the ability to adapt and choose the most appropriate algorithm for a given data set is crucial. Classical methods lack this flexibility, often relying on static algorithms that may not be optimal for all scenarios. This rigidity leads to suboptimal performance and reduces the overall effectiveness of data analysis and anomaly detection processes. The need fora more adaptive and dynamic approach is evident, as it would enable more accurate and efficient analysis of diverse data sets.

The scalability of classical computing methods is another significant concern. As data volumes grow, the computational resources required to process them increase dramatically. Classical methods struggle to scale effectively, resulting in longer processing times and higher costs. This scalability issue is particularly problematic for organizations dealing with large-scale data sets. The inability to scale efficiently limits the potential for these organizations to leverage their data fully, hindering innovation and progress.

Additionally, the sequential nature of classical computing methods limits their ability to handle real-time data analysis. In many applications, such as cybersecurity and financial trading, real-time data analysis is critical. Delays in processing can lead to missed opportunities or failure to detect threats promptly. Classical methods, with their inherent delays, are inadequate for these time-sensitive applications. A more rapid and simultaneous approach to data analysis is needed to meet the demands of real-time decision-making and threat detection.

The existing methods also face challenges in terms of integrating and processing diverse data types. Modern data sets often include structured, semi-structured, and unstructured data, each requiring different processing techniques. Classical computing methods, with their limited flexibility, struggle to integrate and analyze these diverse data types effectively. This limitation results in fragmented analysis and incomplete insights, reducing the overall value derived from the data. A more versatile and comprehensive approach is necessary to handle the diversity of modern data sets.

The accuracy of classical computing methods in anomaly detection is further compromised by their reliance on traditional statistical techniques. These techniques, while useful, are often inadequate for detecting subtle and complex anomalies in large data sets. Classical methods may overlook these anomalies or misclassify them, leading to gaps in detection and increased risk exposure. The need for more advanced and precise techniques is evident, as they would enhance the ability to identify and respond to anomalies effectively.

Lastly, the reliance on classical computing methods poses a significant barrier to innovation. As new technologies and methodologies emerge, the limitations of classical methods become more apparent. Organizations are unable to fully utilize the potential of their data and are constrained by the inefficiencies and inaccuracies of classical approaches. The lack of a robust and scalable solution impedes progress and innovation across various fields.

There has been a long-felt and unmet need for a solution that overcomes the limitations of classical computing methods in entropy exploratory analysis and anomaly detection. The increasing complexity and volume of data necessitate a more advanced and scalable approach. Quantum computing offers significant advantages in terms of speed, simultaneous execution, accuracy, and scalability, making it an ideal candidate to address these challenges. The development of a quantum-based solution that can handle multi-dimensional data, support dynamic algorithm selection, and execute various algorithms simultaneously would fulfill this unmet need. Such a solution would enable more accurate and efficient data analysis, reduce false positive rates, and enhance the overall effectiveness of anomaly detection systems, thereby driving innovation and progress across multiple domains.

### SUMMARY OF THE INVENTION

In general, the present invention employs a multi-level, vertically classified exploratory analysis system and process with dynamic and combined algorithm selection across different stages. By utilizing varied qubits and quantum computing, this approach offers high speed and high accuracy in detecting anomalies within massive volumes of data.

The tool analyzes multi-staged results using quantum encoding techniques to reach accurate decisions. The number of qubits can vary at different execution stages based on the type of algorithm selected by the tool. This approach incorporates both classical and quantum algorithms, leveraging the strengths of each.

Quantum computing brings significant advantages in speed, simultaneous execution, accuracy, and scalability. It has the potential to enhance entropy exploratory analysis and anomaly detection through faster computations and improved accuracy. The tool supports multi-dimensional data, including large volumes of financial data, and can execute simultaneously using varied qubits to generate accurate analytical findings.

In a multi-dimensional staged environment, various classified algorithms are executed vertically. The splitter and aggregator components handle parallel execution, while selectors identify the most accurate data using multiple simulators. This combination ensures efficient and precise data analysis, making the tool highly effective in processing complex data sets.

The inventive approach enhances the tool's capability to process massive volumes of data, improve the accuracy of anomaly detection, and support the simultaneous execution of various algorithms. Key components include one or more of:
a. Quantum Encoder: The quantum encoder is responsible for encoding data into quantum states that can be processed by quantum algorithms. This component leverages the principles of quantum superposition and entanglement to enable more complex and precise data analysis than classical encoding methods. Quantum encoding allows the tool to analyze multi-dimensional data sets with higher accuracy and lower false positive rates.
b. Dynamic Algorithm Selector: This component allows the system to adaptively choose the most suitable algorithms for the data being analyzed. The dynamic algorithm selector ensures that the tool can handle a wide range of data types and analysis needs by selecting and executing the optimal algorithms at various stages of the analysis process. This flexibility enhances the tool's efficiency and effectiveness.
c. Multi-Level Splitter and Aggregator: The splitter divides the data into smaller, more manageable segments that can be analyzed independently. The aggregator then combines the results from these segments to form a comprehensive overview. This multi-level approach ensures that the tool can handle large-scale data sets efficiently without compromising on accuracy or speed. Specifically, the splitter and aggregator of parallel execution allow multiple algorithms to process data segments simultaneously, significantly reducing processing time and improving efficiency. The selectors identify the most accurate data by using multiple simulators, ensuring that only the best results are aggregated and analyzed further.
d. Qubit Selector: The qubit selector determines the optimal number of qubits to be used in each stage of the analysis. The number of qubits can vary based on the specific requirements of the algorithm and the data set, allowing the system to optimize the use of quantum resources. This dynamic selection process enhances the system's efficiency and accuracy.
e. Classification Executor: The classification executor integrates the results from the multi-staged execution process and uses advanced quantum computing techniques to ensure that these decisions are accurate and reliable. By combining the outputs of various algorithms and stages, the classification executor provides a more thorough and precise analysis than would be possible with a single algorithm or stage.
f. Exploratory Data Analyzer: This component provides in-depth insights into the data being analyzed. It uses a combination of classical and quantum algorithms to explore the data from multiple perspectives, uncovering hidden patterns and anomalies that might be overlooked by traditional methods. The exploratory data analyzer helps users gain valuable insights that can inform decision-making and strategic planning.
g. Multi-Dimensional Data Processor: Designed to handle the complexity and diversity of modern data sets, the multi-dimensional data processor uses advanced quantum computing techniques to process and analyze data across multiple dimensions simultaneously. This capability is essential for applications requiring the analysis of large and complex data sets.

Unique aspects of the invention include the tool's unique multi-level vertically classified exploratory analysis technique with dynamic and combined algorithm selection across different stages, leveraging varied qubits, provides high speed and high accuracy in finding anomalies. This technical approach significantly improves the speed, accuracy, and scalability of data analysis processes compared to classical computing methods.

The invention is particularly valuable for applications requiring rapid and precise data analysis, such as finance, cybersecurity, and scientific research. It significantly reduces false positive rates and improves processing efficiency, addressing the limitations of classical methods in handling large-scale, multi-dimensional data sets. The hybrid approach of combining classical and quantum computing methods enhances the tool's robustness and versatility, making it suitable for a wide range of data analysis needs.

This multi-level quantum-based vertically classified entropy exploratory analytics tool represents a significant advancement in data processing systems employing artificial intelligence techniques. By leveraging the power of quantum computing, the tool provides a more efficient and effective method for entropy exploratory analysis and anomaly detection, driving innovation and progress across multiple domains.

More specifically, the invention provides a comprehensive solution to the pressing issues associated with entropy exploratory analysis and anomaly detection in large and complex data sets. At its core, it leverages the principles of quantum computing to significantly improve the speed, accuracy, and scalability of data analysis processes. Traditional classical computing methods are often slow and inefficient when handling the vast amounts of data generated in today's digital age. They require substantial memory and processing power and are limited to sequential algorithm execution, which is inadequate for modern data needs. By contrast, the invention employs a multi-level quantum-based vertically classified exploratory analysis technique that enables simultaneous execution of various algorithms, providing faster and more accurate results.

A central feature of this invention is the dynamic algorithm selector, which allows the system to adaptively choose the most suitable algorithms for the data being analyzed. This flexibility is crucial because different data sets and analysis scenarios require different approaches. The dynamic algorithm selector ensures that the tool can handle a wide range of data types and analysis needs by selecting and executing the optimal algorithms at various stages of the analysis process. This adaptability enhances the tool's efficiency and effectiveness, making it suitable for diverse applications.

The quantum encoder is another critical component of the invention, responsible for encoding data into quantum states that can be processed by quantum algorithms. This component leverages the principles of quantum superposition and entanglement to enable more complex and precise data analysis than classical encoding methods. By using quantum encoding, the tool can analyze multi-dimensional data sets with higher accuracy and lower false positive rates, which is a significant improvement over traditional method. This capability is especially important in fields where precision is critical, such as financial fraud detection and cybersecurity.

The invention also incorporates a multi-level splitter and aggregator, which plays a vital role in managing the data during the analysis process. The splitter divides the data into smaller, more manageable segments that can be analyzed independently, while the aggregator combines the results from these segments to form a comprehensive overview. This multi-level approach ensures that the tool can handle large-scale data sets efficiently without compromising on accuracy or speed. By distributing the workload across multiple stages and then aggregating the results, the system can process large volumes of data more effectively.

The classification executor is responsible for making the final decisions based on the analyzed data. It integrates the results from the multi-staged execution process and uses advanced quantum computing techniques to ensure that these decisions are accurate and reliable. By combining the outputs of various algorithms and stages, the classification executor can provide a more thorough and precise analysis than would be possible with a single algorithm or stage. This comprehensive approach enhances the reliability of the anomaly detection process, reducing false positives and improving overall accuracy.

The exploratory data analyzer component of the invention provides in-depth insights into the data being analyzed. It uses a combination of classical and quantum algorithms to explore the data from multiple perspectives, uncovering hidden patterns and anomalies that might be overlooked by traditional methods. This component is designed to work seamlessly with the other parts of the tool, ensuring that the analysis is both thorough and accurate. By providing a detailed examination of the data, the exploratory data analyzer helps users gain valuable insights that can inform decision-making and strategic planning.

The multi-dimensional data processor is designed to handle the complexity and diversity of modern data sets, which often include structured, semi-structured, and unstructured data. This component uses advanced quantum computing techniques to process and analyze data across multiple dimensions simultaneously, providing a more comprehensive understanding of the data. By leveraging the power of quantum computing, the multi-dimensional data processor can handle larger and more complex data sets than would be possible with classical methods. This capability is essential for applications that require the analysis of large and complex data sets, such as scientific research and big data analytics.

Another innovative feature of the invention is the qubit selector, which determines the optimal number of qubits to be used in each stage of the analysis. The number of qubits can vary based on the specific requirements of the algorithm and the data set, allowing the system to optimize the use of quantum resources. This dynamic selection process ensures that the tool can adapt to different analysis needs, enhancing its efficiency and accuracy. By carefully managing the allocation of qubits, the qubit selector helps maximize the system's performance and ensures that the analysis is both effective and efficient.

The invention also demonstrates a unique capability to combine classical and quantum computing methods. This hybrid approach allows the tool to leverage the strengths of both classical and quantum techniques, providing a more robust and versatile solution to the challenges of entropy exploratory analysis and anomaly detection. Classical methods are often limited by their sequential processing capabilities, while quantum computing offers significant advantages in parallel processing and handling complex data sets. By integrating these two approaches, the tool can provide more accurate and reliable results than would be possible with either method alone.

In terms of scalability, the invention represents a significant advancement over traditional methods. As data volumes continue to grow, the ability to scale effectively becomes increasingly important. Classical computing methods often struggle to handle large-scale data sets due to their substantial memory and processing requirements. The invention, however, leverages the power of quantum computing to process large volumes of data more efficiently, reducing the computational resources needed and improving overall scalability. This makes the tool particularly valuable for organizations that need to analyze large data sets quickly and accurately.

Overall, the invention provides a comprehensive and advanced solution to the limitations of classical computing methods in entropy exploratory analysis and anomaly detection. By leveraging quantum computing and combining it with classical techniques, the tool offers significant improvements in speed, accuracy, and scalability. The dynamic algorithm selector, quantum encoder, multi-level splitter and aggregator, classification executor, exploratory data analyzer, multi-dimensional data processor, and qubit selector work together to provide a robust and versatile solution capable of handling the complexity and diversity of modern data sets. This innovative approach addresses the long-felt and unmet need for a more efficient and effective method of analyzing and interpreting large volumes of data, providing valuable insights and enhancing decision-making processes across various fields.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for multi-level quantum-based vertically classified entropy exploratory analytics comprises the steps of collecting multi-dimensional transactional data from various sources. The method further includes preprocessing the collected data by performing data cleaning, normalization, feature engineering, and integration to produce a preprocessed dataset.

The method applies dimensionality reduction techniques, including Principal Component Analysis (PCA), t-Distributed Stochastic Neighbor Embedding (t-SNE), Linear Discriminant Analysis (LDA), and Autoencoders, to the preprocessed dataset to obtain a reduced-dimensionality dataset. Exploratory data analysis is performed on the reduced-dimensionality dataset to uncover patterns, relationships, and anomalies.

The analyzed data is then encoded into quantum states using a quantum encoder, leveraging principles of quantum superposition and entanglement. The method dynamically selects the most suitable algorithms and features for the quantum-encoded data using an algorithm selector and a feature selector, incorporating data simulation and scenario analysis.

The quantum-encoded data is processed using quantum algorithms, including Shor's Algorithm, Grover's Algorithm, Quantum Approximate Optimization Algorithm (QAOA), and Variational Quantum Eigensolver (VQE), executed through quantum circuits with qubits and quantum gates. The performance of the selected algorithms is continuously monitored and adapted in real-time based on performance metrics to optimize their efficiency and accuracy. Finally, the results from multiple stages of algorithm execution are aggregated and presented in a user-friendly format, ensuring accurate and comprehensive data insights.

In some arrangements, the method further comprises handling missing values in the preprocessing step by employing imputation techniques to fill in missing data points.

In some arrangements, the normalization step in preprocessing involves scaling the data to a standard range, eliminating discrepancies due to different units of measurement.

In some arrangements, the feature engineering step in preprocessing includes generating interaction terms, polynomial features, and domain-specific variables to enhance the predictive power of the algorithms.

In some arrangements, the data integration step involves merging datasets from multiple sources, resolving data conflicts, and ensuring consistency across different data sources.

In some arrangements, the dimensionality reduction step further comprises using autoencoders to learn efficient encodings of the data, capturing the most important features and patterns.

In some arrangements, the exploratory data analysis step utilizes techniques such as t-SNE for visualizing high-dimensional data by converting similarities between data points into joint probabilities and minimizing the divergence between these joint probabilities in a lower-dimensional space.

In some arrangements, the dynamic selection of algorithms includes evaluating each algorithm based on historical performance on similar datasets, providing a benchmark for expected performance.

In some arrangements, the continuous monitoring step involves real-time adjustment of algorithm parameters, switching algorithms, or incorporating new features based on real-time performance metrics.

In some arrangements, the aggregation step involves using multiple simulators to identify the most accurate data, ensuring that only the best results are aggregated and analyzed further.

In some arrangements, a method for multi-level quantum-based vertically classified entropy exploratory analytics comprises the steps of collecting multi-dimensional transactional data from various sources, including databases, sensors, and user interactions, to form an aggregated dataset. The method further includes preprocessing the collected data by performing data cleaning, including identifying and correcting errors, inconsistencies, and missing values using imputation techniques, normalization to scale the data to a standard range, feature engineering to create new features such as interaction terms, polynomial features, and domain-specific variables, and data integration to merge datasets from multiple sources, resolve data conflicts, and ensure consistency across different data formats, to produce a preprocessed dataset.

The method applies dimensionality reduction techniques, including Principal Component Analysis (PCA) to transform the data into a set of linearly uncorrelated variables called principal components, t-Distributed Stochastic Neighbor Embedding (t-SNE) to visualize high-dimensional data by converting similarities between data points into joint probabilities and minimizing divergence in a lower-dimensional space, Linear Discriminant Analysis (LDA) to project the data onto a lower-dimensional space where the classes are distinct, and Autoencoders to learn efficient encodings of the data, capturing the most important features and patterns, to the preprocessed dataset to obtain a reduced-dimensionality dataset. Exploratory data analysis is performed on the reduced-dimensionality dataset to uncover patterns, relationships, and anomalies, utilizing statistical summaries including measures of central tendency, variability, and distribution shape, and creating visualizations such as histograms to show frequency distribution, scatter plots to illustrate relationships between variables, and box plots to provide a summary of the data distribution, to understand data distribution and identify relationships between variables.

The analyzed data is then encoded into quantum states using a quantum encoder, leveraging principles of quantum superposition and entanglement, and employing quantum gates, including Hadamard gates for creating superposition, Pauli-X, Pauli-Y, and Pauli-Z gates for performing rotations on qubits, and CNOT (controlled-NOT) gates for entangling qubits, to transform the data into quantum-compatible format using quantum circuits. The method dynamically selects the most suitable algorithms and features for the quantum-encoded data using an algorithm selector and a feature selector, incorporating data simulation to create synthetic datasets that mimic real data characteristics, scenario analysis to explore hypothetical situations, and adaptive selection processes to refine algorithm choices based on real-time performance metrics.

The quantum-encoded data is processed using quantum algorithms, including Shor's Algorithm for factoring large integers, Grover's Algorithm for searching unsorted databases, Quantum Approximate Optimization Algorithm (QAOA) for solving combinatorial optimization problems, and Variational Quantum Eigensolver (VQE) for finding the lowest eigenvalue of a given Hamiltonian, executed through quantum circuits with qubits and quantum gates, leveraging superposition and quantum interferences to amplify correct solutions and diminish incorrect ones. The performance of the selected algorithms is continuously monitored and adapted in real-time based on performance metrics, including accuracy, precision, recall, F1 score, and computational efficiency, to optimize their efficiency and accuracy, adjusting algorithm parameters, switching algorithms, or incorporating new features as necessary. The results from multiple stages of algorithm execution are aggregated, weighing the reliability and relevance of each result, using multiple simulators to identify the most accurate data, and combining them to form a comprehensive analysis, ensuring that only the best results are aggregated and analyzed further. Finally, the final analysis results are presented in a user-friendly format, including charts, graphs, and reports, ensuring accurate and comprehensive data insights for informed decision-making.

In some arrangements, the method further comprises handling missing values in the preprocessing step by employing imputation techniques to fill in missing data points.

In some arrangements, the normalization step in preprocessing involves scaling the data to a standard range, eliminating discrepancies due to different units of measurement.

In some arrangements, the feature engineering step in preprocessing includes generating interaction terms, polynomial features, and domain-specific variables to enhance the predictive power of the algorithms.

In some arrangements, the data integration step involves merging datasets from multiple sources, resolving data conflicts, and ensuring consistency across different data sources.

In some arrangements, the dimensionality reduction step further comprises using autoencoders to learn efficient encodings of the data, capturing the most important features and patterns.

In some arrangements, the exploratory data analysis step utilizes techniques such as t-SNE for visualizing high-dimensional data by converting similarities between data points into joint probabilities and minimizing the divergence between these joint probabilities in a lower-dimensional space.

In some arrangements, the dynamic selection of algorithms includes evaluating each algorithm based on historical performance on similar datasets, providing a benchmark for expected performance.

In some arrangements, the continuous monitoring step involves real-time adjustment of algorithm parameters, switching algorithms, or incorporating new features based on real-time performance metrics.

In some arrangements, the aggregation step involves using multiple simulators to identify the most accurate data, ensuring that only the best results are aggregated and analyzed further.

In some arrangements, a system for multi-level quantum-based vertically classified entropy exploratory analytics comprises a data collection module configured to collect multi-dimensional transactional data from various sources, including databases, sensors, and user interactions, to form an aggregated dataset. The system further includes a preprocessing module configured to perform data cleaning by identifying and correcting errors, inconsistencies, and missing values using imputation techniques; normalization to scale the data to a standard range; feature engineering to create new features such as interaction terms, polynomial features, and domain-specific variables; and data integration to merge datasets from multiple sources, resolve data conflicts, and ensure consistency across different data formats, producing a preprocessed dataset.

The system applies dimensionality reduction techniques through a dimensionality reduction module configured to apply Principal Component Analysis (PCA) to transform the data into a set of linearly uncorrelated variables called principal components, t-Distributed Stochastic Neighbor Embedding (t-SNE) to visualize high-dimensional data by converting similarities between data points into joint probabilities and minimizing divergence in a lower-dimensional space, Linear Discriminant Analysis (LDA) to project the data onto a lower-dimensional space where the classes are distinct, and Autoencoders to learn efficient encodings of the data, capturing the most important features and patterns, to the preprocessed dataset to obtain a reduced-dimensionality dataset.

The system includes an exploratory data analysis module configured to perform exploratory data analysis on the reduced-dimensionality dataset to uncover patterns, relationships, and anomalies. This module utilizes statistical summaries including measures of central tendency, variability, and distribution shape, and creates visualizations such as histograms to show frequency distribution, scatter plots to illustrate relationships between variables, and box plots to provide a summary of the data distribution, to understand data distribution and identify relationships between variables.

A quantum encoding module is configured to encode the analyzed data into quantum states, leveraging principles of quantum superposition and entanglement, and employing quantum gates, including Hadamard gates for creating superposition, Pauli-X, Pauli-Y, and Pauli-Z gates for performing rotations on qubits, and CNOT (controlled-NOT) gates for entangling qubits, to transform the data into quantum-compatible format using quantum circuits.

An algorithm and feature selection module is configured to dynamically select the most suitable algorithms and features for the quantum-encoded data, incorporating data simulation to create synthetic datasets that mimic real data characteristics, scenario analysis to explore hypothetical situations, and adaptive selection processes to refine algorithm choices based on real-time performance metrics.

The system further includes a quantum processing module configured to process the quantum-encoded data using quantum algorithms, including Shor's Algorithm for factoring large integers, Grover's Algorithm for searching unsorted databases, Quantum Approximate Optimization Algorithm (QAOA) for solving combinatorial optimization problems, and Variational Quantum Eigensolver (VQE) for finding the lowest eigenvalue of a given Hamiltonian, executed through quantum circuits with qubits and quantum gates, leveraging superposition and quantum interferences to amplify correct solutions and diminish incorrect ones.

A performance monitoring module is configured to continuously monitor the performance of the selected algorithms and adapt them in real-time based on performance metrics, including accuracy, precision, recall, F1 score, and computational efficiency, to optimize their efficiency and accuracy, adjusting algorithm parameters, switching algorithms, or incorporating new features as necessary.

An aggregation module is configured to aggregate the results from multiple stages of algorithm execution, weighing the reliability and relevance of each result, using multiple simulators to identify the most accurate data, and combining them to form a comprehensive analysis, ensuring that only the best results are aggregated and analyzed further.

Finally, a results presentation module is configured to present the final analysis results in a user-friendly format, including charts, graphs, and reports, ensuring accurate and comprehensive data insights for informed decision-making.

In some arrangements, the preprocessing module is further configured to handle missing values using imputation techniques to fill in missing data points and the normalization process in the preprocessing module involves scaling the data to a standard range, eliminating discrepancies due to different units of measurement.

In some arrangements, the feature engineering process in the preprocessing module includes generating interaction terms, polynomial features, and domain-specific variables to enhance the predictive power of the algorithms.

In some arrangements, the data integration process in the preprocessing module involves merging datasets from multiple sources, resolving data conflicts, and ensuring consistency across different data sources.

In some arrangements, the dimensionality reduction module further comprises using autoencoders to learn efficient encodings of the data, capturing the most important features and patterns.

In some arrangements, the exploratory data analysis module utilizes techniques such as t-SNE for visualizing high-dimensional data by converting similarities between data points into joint probabilities and minimizing the divergence between these joint probabilities in a lower-dimensional space.

In some arrangements, the algorithm and feature selection module include evaluating each algorithm based on historical performance on similar datasets, providing a benchmark for expected performance.

In some arrangements, the performance monitoring module involves real-time adjustment of algorithm parameters, switching algorithms, or incorporating new features based on real-time performance metrics.

In some arrangements, the aggregation module uses multiple simulators to identify the most accurate data, ensuring that only the best results are aggregated and analyzed further.

The following description and claims, in conjunction with the drawings-all integral parts of this specification-will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 illustrates an overview of the technical approach employed in the present invention from input of transactional data to processing by a multi-level classification analyzer that feeds a multi-level algorithm engine and exploratory data analyzer. Output is provided to a quantum encoder and dynamic algorithm and feature selector, which processing proceeding with execution of quantum algorithms that produce result data.

FIG. 2 illustrates a sample multi-level classification analyzer in showing how transactional data is processed through a dynamic algorithm selector and classification executor. It highlights the execution of multiple algorithms and their integration to produce accurate and comprehensive final output results.

FIG. 3 illustrates the sample exploratory data analyzer, detailing the stages of data ingestion, preprocessing, dimensionality reduction, and exploratory analysis. It highlights the processes of data cleaning, normalization, feature engineering, and visualization techniques used to uncover patterns and relationships within the data.

FIG. 4 illustrates a sample dynamic algorithm and feature selector process, showcasing stages such as data ingestion, initial feature selection, algorithm evaluation, and simulation and scenario analysis. It demonstrates how the system dynamically adapts to optimize the selection of algorithms and features, ensuring efficient and accurate data analysis.

FIG. 5 illustrates a sample quantum algorithm process, detailing the steps of data ingestion, quantum preprocessing, initial feature selection, and quantum feature engineering. It also shows the stages of algorithm evaluation, parallel evaluation, simulation and scenario analysis, dynamic adaptation, real-time optimization, and final selection, highlighting the comprehensive approach to leveraging quantum computing for data analysis.

FIG. 6 illustrates a sample combined classical and quantum execution method, showing how transactional data undergoes data preprocessing, training and sampling, and dynamic classified algorithms selection. It highlights the simultaneous execution of multiple algorithms, the application of quantum encoding and simulations, and the integration of results to produce accurate and efficient data analysis outcomes.

FIG. 7 illustrates a sample sequence diagram for performing multi-level quantum-based vertically classified entropy exploratory analytics. The figure outlines the interaction steps between the user and various system modules, including data collection, preprocessing, dimensionality reduction, exploratory data analysis, quantum encoding, algorithm and feature selection, quantum processing, performance monitoring, aggregation, and result presentation.

FIG. 8 provides a sample class diagram for an exemplary system, detailing the various modules and their respective functions. It includes the Data Collection Module, Preprocessing Module, Dimensionality Reduction Module, Exploratory Data Analysis Module, Quantum Encoding Module, Algorithm and Feature Selection Module, Quantum Processing Module, Performance Monitoring Module, Aggregation Module, and Results Presentation Module, along with handlers for specific processes like missing values, normalization, feature engineering, data integration, autoencoders, t-SNE, algorithm evaluating, real-time adjustment, and multiple simulators.

### DETAILED DESCRIPTION

At a high level, the invention detailed in herein is a multi-level quantum-based vertically classified entropy exploratory analytics tool designed to enhance the speed, accuracy, and scalability of anomaly detection and data analysis. This innovative tool leverages the significant advantages of quantum computing over classical methods, including simultaneous execution, improved precision, and the ability to handle massive volumes of data efficiently. The core aspect of the invention lies in its multi-level exploratory analysis technique, which dynamically selects and combines algorithms at various stages using varied qubits, resulting in high-speed and high-accuracy anomaly detection.

A key feature of the invention is the quantum encoder, which encodes data into quantum states, allowing for more complex and precise analysis than classical encoding methods. This component uses the principles of quantum superposition and entanglement to handle multi-dimensional data sets with higher accuracy and lower false positive rates. The dynamic algorithm selector is another critical component that adapts to the data being analyzed by choosing the most suitable algorithms for different stages of the analysis process. This flexibility ensures that the tool can efficiently process a wide range of data types and analysis needs.

The multi-level splitter and aggregator play a vital role in managing data during the analysis process. The splitter divides the data into smaller segments that can be analyzed independently, while the aggregator combines the results from these segments to form a comprehensive overview. This approach allows for efficient handling of large-scale data sets without compromising on accuracy or speed. The classification executor integrates the results from the multi-staged execution process and uses advanced quantum computing techniques to ensure accurate and reliable decisions.

Another significant component is the exploratory data analyzer, which provides in-depth insights into the data by using a combination of classical and quantum algorithms. This component uncovers hidden patterns and anomalies that might be overlooked by traditional methods, aiding in strategic decision-making and planning. The multi-dimensional data processor is designed to handle the complexity and diversity of modern data sets, processing and analyzing data across multiple dimensions simultaneously using advanced quantum computing techniques.

The qubit selector determines the optimal number of qubits to be used in each stage of the analysis, optimizing the use of quantum resources and enhancing the system's efficiency and accuracy. This dynamic selection process allows the tool to adapt to different analysis needs, ensuring effective and efficient performance. The tool also combines classical and quantum computing methods, leveraging the strengths of both to provide a more robust and versatile solution to the challenges of entropy exploratory analysis and anomaly detection.

The invention addresses the limitations of classical computing methods, which often struggle with speed, accuracy, and scalability when processing large volumes of data. Classical methods require substantial memory and storage and are limited to sequential algorithm execution, making them inadequate for modern data needs, especially when dealing with multi-dimensional data sets. By contrast, the invention employs a multi-level quantum-based exploratory analysis technique that enables the simultaneous execution of various algorithms, providing faster and more accurate results.

This innovative approach significantly reduces false positive rates and improves processing efficiency, making the tool particularly valuable for applications requiring rapid and precise data analysis, such as finance, cybersecurity, and scientific research. The hybrid approach of combining classical and quantum computing methods enhances the tool's robustness and versatility, making it suitable for a wide range of data analysis needs.

In summary, this multi-level quantum-based vertically classified entropy exploratory analytics tool represents a significant advancement in data processing systems employing artificial intelligence techniques. By leveraging quantum computing, the tool provides a more efficient and effective method for entropy exploratory analysis and anomaly detection, driving innovation and progress across multiple domains. The invention fulfills the long-felt and unmet need for a solution that overcomes the limitations of classical computing methods, offering significant improvements in speed, accuracy, and scalability in handling large and complex data sets.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

Terms such as “computers,” “machines,” and similar phrases are used interchangeably based on the context to denote devices that may be general-purpose or specialized for specific functions, whether virtual or physical, and capable of network connectivity. This encompasses all pertinent hardware, software, and components known to those skilled in the field. Such devices might feature specialized circuits like application-specific integrated circuits (ASICs), microprocessors, cores, or other processing units for executing, accessing, controlling, or implementing various types of software, instructions, data, modules, processes, or routines. The employment of these terms within this document is not intended to restrict or exclusively refer to any specific type of electronic devices or components, and should be interpreted broadly by those with relevant expertise. For conciseness and assuming familiarity, detailed descriptions of computer/software components and machines are omitted.

Software, executable code, data, modules, procedures, and similar entities may reside on tangible, physical computer-readable storage devices. This includes a range from local memory to network-attached storage, and various other accessible memory types, whether removable, remote, cloud-based, or accessible through other means. These elements can be stored in both volatile and non-volatile memory forms and may operate under different conditions such as autonomously, on-demand, as per a preset schedule, spontaneously, proactively, or in response to certain triggers. They may be consolidated or distributed across multiple computers or devices, integrating their memory and other components. These elements can also be located or dispersed across network-accessible storage systems, within distributed databases, big data infrastructures, blockchains, or distributed ledger technologies, whether collectively or in distributed configurations.

The term “networks” and similar references encompass a wide array of communication systems, including local area networks (LANs), wide area networks (WANs), the Internet, cloud-based networks, and both wired and wireless configurations. This category also covers specialized networks such as digital subscriber line (DSL) networks, frame relay networks, asynchronous transfer mode (ATM) networks, and virtual private networks (VPN), which may be interconnected in various configurations. Networks are equipped with specific interfaces to facilitate diverse types of communications—internal, external, and administrative—and have the ability to assign virtual IP addresses (VIPs) as needed. Network architecture involves a suite of hardware and software components, including but not limited to access points, network adapters, buses, both wired and wireless ethernet adapters, firewalls, hubs, modems, routers, and switches, which may be situated within the network, on its edge, or externally. Software and executable instructions operate on these components to facilitate network functions. Moreover, networks support HTTPS and numerous other communication protocols, enabling them to handle packet-based data transmission and communications effectively.

As used herein, Generative Artificial Intelligence (AI) or the like refers to AI techniques that learn from a representation of training data and use it to generate new content similar to or inspired by existing data. Generated content may include human-like outputs such as natural language text, source code, images/videos, and audio samples. Generative AI solutions typically leverage open-source or vendor sourced (proprietary) models, and can be provisioned in many ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used under various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models—Meta LLaMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in biology and medicine. (5) NVIDIA AI Models—Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in generative AI. One or more of the foregoing may be used herein as desired. All are considered within the sphere and scope of this disclosure.

Generative AI and LLMs can be used in various parts of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and using large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another. A person of skill in the art will recognize that machine language, as used herein, includes and is also interchangeable with generative AI and large language models. All are considered within the scope of the discussions and examples that reference ML.

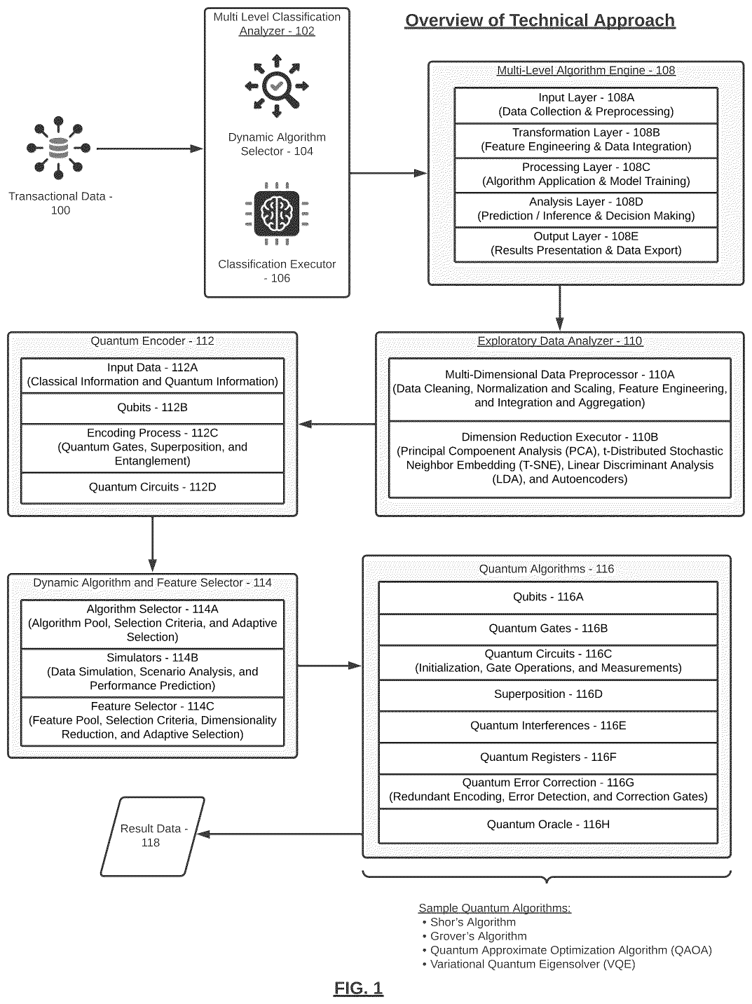

FIG. 1, by way of non-limiting disclosure, depicts illustrates an overview of the technical approach employed in the present invention from input of transactional data to processing by a multi-level classification analyzer that feeds a multi-level algorithm engine and exploratory data analyzer. Output is provided to a quantum encoder and dynamic algorithm and feature selector, which processing proceeding with execution of quantum algorithms that produce result data. Each component helps in the process of transforming raw data into actionable insights, leveraging both classical and quantum computing techniques to achieve high speed, accuracy, and scalability.

The process begins with Transactional Data (100), which serves as the input to the system. This transactional data consists of raw information that needs to be analyzed for anomalies and patterns. It can come from various sources such as financial transactions, sensor data, or user interactions. Transactional data is a key input that drives the entire analysis process and requires meticulous handling to ensure accurate results.

The Multi-Level Classification Analyzer (102) is the first major processing unit for the transactional data. This analyzer includes a Dynamic Algorithm Selector (104) and a Classification Executor (106). The Dynamic Algorithm Selector is a component of the multi-level classification analyzer that dynamically selects the most suitable algorithms for analyzing the given dataset. This selection process is adaptive and responsive to the specific characteristics of the data and the requirements of the analysis task. The process begins with evaluating a diverse pool of potential algorithms, including classical machine learning methods such as decision trees, support vector machines, and neural networks, as well as quantum algorithms like Grover's search algorithm and the Quantum Approximate Optimization Algorithm.

To ensure the best performance, the Dynamic Algorithm Selector uses a set of predefined criteria to evaluate each algorithm. These criteria include accuracy, which measures the algorithm's ability to correctly predict outcomes or classify data points using metrics such as precision, recall, F1 score, and area under the receiver operating characteristic (ROC) curve. Efficiency is another key criterion, focusing on the computational resources required by the algorithm, including time complexity and space complexity. This is particularly important for handling large datasets or real-time data processing. Additionally, the relevance of the algorithm to the specific features and structure of the data is considered. Some algorithms are more effective with high-dimensional data, while others excel with sparse data or time series.

Each algorithm in the pool is profiled based on its historical performance on similar datasets, providing a benchmark for expected performance on the current dataset. The selection process is adaptive, allowing the system to adjust its choices as more information about the dataset becomes available. Initially, the Dynamic Algorithm Selector might choose a set of candidate algorithms based on preliminary evaluations. As the analysis progresses and more data is processed, the selector can refine its choices, adding new algorithms or discarding those that are underperforming. This adaptive nature ensures flexibility and responsiveness to changes in the data or analysis requirements, which is especially important in dynamic environments where data characteristics might evolve over time.

Once a subset of algorithms is selected, the Dynamic Algorithm Selector performs testing and validation by running the algorithms on a portion of the dataset, such as a validation set, and comparing their performance against the predefined criteria. Techniques like k-fold cross-validation ensure that the selected algorithms generalize well to unseen data, helping to avoid overfitting and ensuring robust performance on new data.

In some cases, the Dynamic Algorithm Selector might choose to use a combination of algorithms rather than a single one. Ensemble methods, such as bagging, boosting, and stacking, combine multiple algorithms to improve overall performance by leveraging the strengths of different algorithms. Hybrid approaches that combine classical and quantum algorithms can also be selected. For example, a classical algorithm might be used for initial data preprocessing and feature extraction, followed by a quantum algorithm for complex pattern recognition and optimization tasks.

For applications requiring real-time data analysis, the Dynamic Algorithm Selector can adapt its choices on the fly. As new data streams in, the system continuously evaluates the performance of the selected algorithms and adjust as needed. This real-time adaptation ensures that the most effective algorithms are always in use, providing timely and accurate insights. The system incorporates a feedback mechanism where the results of the analysis are used to further refine the algorithm selection process. This involves monitoring the performance of the algorithms over time and using this information to update the selection criteria and algorithm profiles. Continuous feedback helps in improving the accuracy and efficiency of the Dynamic Algorithm Selector.

By dynamically selecting the most suitable algorithms, the Dynamic Algorithm Selector ensures that the analysis process is both efficient and accurate. It leverages the strengths of various algorithms and adapts to the specific needs of the dataset and the analysis task, providing a flexible and powerful tool for data analysis and anomaly detection.

The Classification Executor then executes the selected algorithms to classify the data into different categories or to detect anomalies. This process involves a meticulous and strategic execution of multiple algorithms to ensure a thorough and comprehensive analysis. The executor is capable of running these algorithms both simultaneously and in sequence, depending on the requirements of the data and the complexity of the analysis.

When algorithms are executed simultaneously, the Classification Executor takes advantage of parallel processing. This method allows the system to handle large volumes of data more efficiently, significantly reducing the time needed for analysis. Parallel execution is particularly beneficial when dealing with extensive datasets or when quick results are necessary. By running multiple algorithms at the same time, the executor can compare results in real-time, enhancing the accuracy and robustness of the analysis.

In some cases, algorithms may be executed in sequence. Sequential execution is often used when the output of one algorithm serves as the input for another, creating a pipeline of data processing steps. This approach allows for a more refined analysis, where initial classifications or detections can be further processed and validated by subsequent algorithms. Sequential execution ensures that each step of the analysis builds upon the previous one, leading to more precise and reliable results.

The Classification Executor is designed to handle a variety of algorithms, including classical machine learning models like decision trees, support vector machines, and neural networks, as well as advanced quantum algorithms. Each algorithm is applied based on its suitability for the specific data characteristics and analysis requirements. For instance, a decision tree might be used for its interpretability and simplicity, while a neural network could be employed for its ability to handle complex patterns in large datasets. Quantum algorithms, on the other hand, are utilized for their ability to perform certain calculations much faster than classical algorithms, providing a significant advantage in speed and efficiency.

As the Classification Executor processes the data, it continually monitors the performance of each algorithm. Performance metrics such as accuracy, precision, recall, and F1 score are calculated to evaluate how well each algorithm is performing. This continuous monitoring allows the executor to make real-time adjustments, switching algorithms or modifying their parameters to improve results. The flexibility to adapt based on performance ensures that the system remains efficient and effective, even as data characteristics change.

After the execution of the algorithms, the results are meticulously compiled and analyzed. The Classification Executor aggregates the outputs from all the algorithms, considering the strengths and weaknesses of each result. This aggregation process involves weighing the results based on their reliability and relevance, combining them to form a comprehensive analysis. For example, if multiple algorithms identify the same anomaly, the confidence in that detection increases. Conversely, if there are discrepancies among the results, the executor may re-evaluate or apply additional algorithms to resolve the inconsistencies.

The aggregated results are then passed on to the next stage of processing. This stage could involve further analysis, such as deeper pattern recognition, predictive modeling, or decision-making based on the classified data. The seamless transition of data from the Classification Executor to the next stage ensures that all insights gained from the initial analysis are preserved and utilized effectively.

In summary, the Classification Executor plays a pivotal role in the multi-level algorithm engine by executing a diverse set of algorithms to classify data and detect anomalies. Its ability to run algorithms both simultaneously and in sequence provides a flexible and comprehensive approach to data analysis. By continuously monitoring performance and adapting in real-time, the executor ensures accurate and efficient results, which are then passed on for further processing and analysis. This meticulous and strategic execution process enhances the overall effectiveness and reliability of the data analysis system.

Next, the output from the multi-level classification analyzer is provided to the Multi-Level Algorithm Engine (108). This engine processes the data through several layers, each performing specific tasks to transform and analyze the data. The Multi-Level Algorithm Engine is a sophisticated system designed to handle large volumes of data with precision and efficiency, utilizing both classical and quantum computing techniques to achieve optimal performance.

The Input Layer (108A) is responsible for data collection and preprocessing. This layer gathers data from various sources, ensuring that the system has access to a comprehensive dataset. Sources of data can include databases, sensors, user inputs, and external data feeds, each providing valuable information that needs to be aggregated into a single coherent dataset. Preprocessing is a step that involves data cleaning, normalization, and initial feature selection. Data cleaning involves identifying and correcting errors, inconsistencies, and missing values within the dataset, which is essential for maintaining data quality and ensuring accurate analysis. Normalization scales the data to a standard range, which helps to eliminate discrepancies due to different data scales and units, making the data comparable and easier to process. Initial feature selection involves identifying and retaining the most relevant features of the data for subsequent analysis. These preprocessing steps ensure that the data entering the system is clean, standardized, and ready for detailed processing.

The Transformation Layer (108B) focuses on feature engineering and data integration. Feature engineering is the process of creating new features from the existing data that can enhance the predictive power of the algorithms used in the analysis. This might include generating interaction terms, polynomial features, or domain-specific features that provide additional insights into the data. For example, in a financial dataset, feature engineering might involve creating new variables that capture the interaction between different financial indicators, leading to more accurate predictions. Data integration involves combining data from multiple sources into a cohesive dataset. This process ensures that all necessary information is available for analysis, and it might involve merging datasets, resolving data conflicts, and ensuring consistency across various data sources. Integration creates a unified view of the data, which is essential for comprehensive analysis.

The Processing Layer (108C) handles algorithm application and model training. This layer applies various machine learning and statistical algorithms to the transformed data, leveraging both classical and quantum algorithms. Model training involves selecting the best algorithms for the dataset, training them on the data, and optimizing their parameters to achieve the highest possible accuracy and performance. Classical algorithms, such as regression models, decision trees, and support vector machines, are well-suited for a wide range of data analysis tasks. Quantum algorithms, on the other hand, provide significant speed and efficiency advantages for certain types of complex calculations. Quantum algorithms can process large datasets and perform computations much faster than classical algorithms, making them particularly useful for tasks that involve large-scale data analysis and complex pattern recognition. By combining classical and quantum algorithms, the Processing Layer can handle different aspects of data analysis with high efficiency and accuracy.

The Analysis Layer (108D) focuses on prediction, inference, and decision-making. In this layer, trained models are used to make predictions based on new data inputs. Prediction involves using the trained models to forecast future outcomes or identify trends based on the data. Inference involves drawing conclusions from the data and model outputs, identifying patterns, trends, and anomalies. This step is critical for understanding the underlying structure and behavior of the data, and it helps to uncover insights that can inform decision-making. Decision-making uses these insights to make informed decisions, such as detecting fraud in financial transactions, predicting market trends, or identifying cybersecurity threats. The Analysis Layer synthesizes the outputs of various models to provide actionable recommendations and insights, ensuring that the analysis is robust and comprehensive.

The Output Layer (108E) is responsible for results presentation and data export. This layer formats the analysis results into a user-friendly format, such as charts, graphs, and reports, making it easy for users to interpret and act upon the findings. Presentation of results ensures that stakeholders can understand the outcomes of the analysis and make informed decisions based on the insights gained. Additionally, the Output Layer exports the processed data and results to other systems or storage solutions for further use or archival. This ensures that the insights generated by the analysis are accessible and usable for decision-makers. By providing clear and concise presentations of the results, this layer helps stakeholders understand the outcomes and make informed decisions based on the analysis. The ability to export data also facilitates integration with other business processes and systems, enhancing the overall utility of the analysis.

Each layer in the Multi-Level Algorithm Engine plays a role in ensuring that the data is processed accurately and efficiently. By transforming raw data into actionable insights through a structured and systematic approach, the engine leverages both classical and quantum computing techniques to provide high-speed, accurate, and scalable data analysis. This sophisticated system is suitable for various applications, including finance, cybersecurity, and scientific research, where precise and efficient data analysis is critical for making informed decisions. The Multi-Level Algorithm Engine represents a significant advancement in data processing technology, offering a powerful tool for organizations looking to leverage data-driven insights to drive innovation and improve performance.

Following this, the output from the multi-level algorithm engine is fed into the Exploratory Data Analyzer (110), which includes two key components designed to prepare the data for more detailed analysis. The Multi-Dimensional Data Preprocessor (110A) is responsible for handling data cleaning, normalization, scaling, feature engineering, and integration and aggregation. This preprocessor ensures that the data is thoroughly prepared for dimensionality reduction and further analysis by managing various preprocessing tasks. It begins with data cleaning, which involves identifying and correcting errors, inconsistencies, and missing values in the dataset to maintain high data quality. This step ensures that the subsequent analysis is accurate and reliable.

Normalization and scaling are performed to bring the data to a comparable scale. Normalization adjusts the values in the dataset to a common scale without distorting the differences in the ranges of values, making the data more comparable and easier to process. Scaling involves adjusting the data values to fit within a specific range, which is particularly useful when dealing with data that has different units of measurement. Feature engineering is another important task undertaken by the preprocessor. This involves creating new variables or features from the existing data that can provide additional insights and enhance the predictive power of the algorithms. Examples of feature engineering include generating interaction terms, creating polynomial features, and deriving domain-specific variables that can highlight important patterns and relationships within the data.

Integration and aggregation are the final steps handled bythe Multi-Dimensional Data Preprocessor. Integration involves combining data from multiple sources into a single, cohesive dataset. This process ensures that all relevant information is available for analysis and can involve merging datasets, resolving data conflicts, and ensuring consistency across different data sources. Aggregation is the process of summarizing the data by grouping it based on certain criteria and calculating aggregate statistics like sums, averages, or counts. This helps in reducing the complexity of the data and making it more manageable for analysis.

The Dimension Reduction Executor (110B) is the next key component of the Exploratory Data Analyzer. It applies advanced techniques like Principal Component Analysis (PCA), t-Distributed Stochastic Neighbor Embedding (t-SNE), Linear Discriminant Analysis (LDA), and Autoencoders to reduce the dimensionality of the data, making it easier to analyze. Dimensionality reduction simplifies the data while retaining its essential features, which improves the efficiency and effectiveness of the analysis. PCA reduces the data by transforming it into a set of linearly uncorrelated variables called principal components. This technique helps in identifying the directions in which the data varies the most and projecting the data onto these directions to reduce its dimensions.

t-SNE is a technique used for visualizing high-dimensional data by converting similarities between data points into joint probabilities and minimizing the divergence between these joint probabilities in a lower-dimensional space. This method is particularly useful for creating two or three-dimensional maps of high-dimensional datasets, allowing for easier visualization and interpretation. LDA is focused on maximizing the separability between different categories or classes within the data. It projects the data onto a lower-dimensional space where the classes are as distinct as possible, which is useful for classification tasks. Autoencoders are neural networks used for efficient encodings of the data. They learn to compress the data into a lower-dimensional representation and then reconstruct it, capturing the most important features and patterns in the process.

By applying these dimensionality reduction techniques, the Dimension Reduction Executor ensures that the data is transformed into a more manageable form without losing its essential information. This makes it easier to analyze and helps improve the performance of subsequent data analysis and machine learning tasks. The Exploratory Data Analyzer, with its components for data preprocessing and dimensionality reduction, plays a vital role in preparing the data for detailed analysis, ensuring that it is clean, standardized, and simplified for efficient processing.

The processed data from the exploratory data analyzer is then sent to the Quantum Encoder (112). This component is designed to prepare the data for advanced quantum processing, utilizing the unique capabilities of quantum computing to enhance the analysis. The Quantum Encoder includes several sub-components that work together to transform the data into a quantum-compatible format.

The first sub-component is the Input Data Module (112A), which handles both classical information and quantum information as inputs. This module is responsible for encoding classical data into a form that can be processed by quantum algorithms. This preparation step is crucial as it bridges the gap between classical data formats and the quantum processing environment, ensuring that the data is appropriately structured for the upcoming quantum computations.

Qubits (112B) are the fundamental units of quantum information used in the encoding process. Unlike classical bits, which can only represent a 0 or a 1, qubits can represent both 0 and 1 simultaneously due to the principle of superposition. This unique property allows quantum computers to perform many calculations at once, significantly increasing their processing power compared to classical computers. In the context of the Quantum Encoder, qubits serve as the basic building blocks that store and manipulate the encoded data.

The Encoding Process (112C) is a complex procedure that involves the use of quantum gates, superposition, and entanglement to encode data into quantum states. Quantum gates are the quantum equivalent of classical logic gates and are used to perform operations on qubits. Superposition allows qubits to exist in multiple states simultaneously, which is harnessed to process vast amounts of data in parallel. Entanglement is a phenomenon where qubits become interconnected such that the state of one qubit directly influences the state of another, regardless of the distance between them. This property is used to create complex correlations between qubits, enabling advanced computations that are not possible with classical bits.

Quantum Circuits (112D) are sequences of quantum gates designed to perform specific computations on the qubits. These circuits leverage the principles of quantum computing, such as superposition and entanglement, to process the encoded data in highly efficient and powerful ways. Quantum circuits are fundamental to executing quantum algorithms, as they define the operations that transform the initial quantum states into the desired output states. By utilizing quantum circuits, the Quantum Encoder can perform sophisticated data transformations and analyses that significantly enhance the overall processing capability of the system.

Overall, the Quantum Encoder (112) plays a pivotal role in transforming the processed data from the exploratory data analyzer into a format that can be effectively utilized by quantum algorithms. By handling both classical and quantum information, leveraging the unique properties of qubits, and using advanced encoding processes and quantum circuits, the Quantum Encoder ensures that the data is optimally prepared for the subsequent stages of quantum processing. This preparation is essential for maximizing the advantages of quantum computing, enabling the system to perform complex analyses with unprecedented speed and accuracy.

Next, the output from the quantum encoder is provided to the Dynamic Algorithm and Feature Selector (114), a sophisticated system designed to optimize both algorithm and feature selection for the data analysis process.

The first component within this system is the Algorithm Selector (114A), which helps choose the most appropriate algorithms from a diverse pool based on the current data and the specific requirements of the analysis. The selection process involves a thorough evaluation of various algorithms using a set of predefined criteria such as accuracy, efficiency, and relevance to the data's characteristics. To ensure optimal performance, the Algorithm Selector employs adaptive selection processes, allowing it to dynamically adjust its choices as it gathers more information about the dataset and the performance of different algorithms. This continuous refinement process ensures that the system utilizes the most effective algorithms for the given analysis task, thus maximizing accuracy and efficiency.

The second component is the Simulators (114B), which simulate different scenarios to predict the performance of the selected algorithms. These simulators perform data simulation, scenario analysis, and performance prediction, which are essential for validating the choices made by the Algorithm Selector. By simulating various scenarios, the simulators can identify potential issues and optimize the algorithms' performance under different conditions. This step ensures that the selected algorithms are well-suited to the specific analysis task and can handle the data's complexities effectively.

The third component is the Feature Selector (114C), which focuses on selecting the most relevant features for the analysis. The Feature Selector ensures that the algorithms work with the most important and informative data, enhancing the overall effectiveness of the analysis. It uses feature pools, selection criteria, dimensionality reduction techniques, and adaptive selection processes to identify and prioritize the features that will have the most significant impact on the analysis. This process helps to reduce the dimensionality of the data, making it more manageable and improving the performance of the algorithms by focusing on the most informative aspects of the data.

Together, these components ensure that the Dynamic Algorithm and Feature Selector optimally prepares the data for analysis by choosing the best algorithms and features. This system's adaptive and simulation-based approach ensures that the analysis is both accurate and efficient, capable of handling complex datasets and delivering reliable results. By leveraging advanced selection and simulation techniques, the Dynamic Algorithm and Feature Selector enhances the overall performance and accuracy of the data analysis process, making it a helpful component of the multi-level algorithm engine.

The next stage involves Quantum Algorithms (116), which processes the data using advanced quantum algorithms. This module includes several key elements that leverage the principles of quantum mechanics to enhance computational capabilities.

Qubits (116A) are the fundamental units of quantum information. Unlike classical bits that can only be in one of two states (0 or 1), qubits can exist in a superposition of states, allowing them to represent both 0 and 1 simultaneously. This unique property significantly increases the computational power of quantum systems. Superposition enables quantum computers to process and store a vast amount of information using fewer qubits compared to classical bits, leading to potentially exponential speed-ups for certain types of calculations. Additionally, qubits can be entangled with each other, creating correlations that are leveraged in many quantum algorithms to perform complex computations more efficiently.

Quantum Gates (116B) are operations applied to qubits to perform computations. These gates are the quantum equivalent of classical logic gates, but they operate on the principles of quantum mechanics. Quantum gates can perform operations exponentially faster than their classical counterparts, enabling complex calculations to be completed in a fraction of the time. Common quantum gates include the Hadamard gate, which creates superposition; the Pauli-X, Pauli-Y, and Pauli-Z gates, which perform rotations on qubits; and the CNOT (controlled-NOT) gate, which entangles qubits. These gates are combined in various sequences to form quantum circuits that implement quantum algorithms.

Quantum Circuits (116C) are sequences of quantum gates applied to qubits for processing. These circuits implement complex quantum algorithms by leveraging superposition and entanglement. Superposition allows qubits to represent multiple states simultaneously, while entanglement creates correlations between qubits that are used for advanced computations. Quantum circuits are essential for executing quantum algorithms that can solve problems more efficiently than classical algorithms. For example, Shor's algorithm, which factors large integers exponentially faster than the best-known classical algorithms, is implemented using quantum circuits that include a series of quantum gates and operations.

Superposition (116D) is a quantum state where qubits can represent multiple states simultaneously. This property allows quantum computers to process a vast number of possibilities at once, providing significant computational advantages over classical computers. By utilizing superposition, quantum algorithms can explore many potential solutions in parallel, drastically reducing the time required for certain computations. This parallelism is one of the key reasons why quantum computers have the potential to solve certain problems much faster than classical computers.

Quantum Interferences (116E) refer to the interactions of quantum states that affect computation outcomes. Interference is used in quantum algorithms to amplify correct solutions and diminish incorrect ones. By carefully controlling these interactions, quantum algorithms can enhance the probability of finding the correct solution to a problem. This control is achieved through the precise application of quantum gates in quantum circuits, which manipulate the probability amplitudes of quantum states to steer the computation towards the desired outcome.

Quantum Registers (116F) are memory locations for qubits used in quantum computations. These registers store qubits during computations, maintaining their quantum states. Quantum registers preserve the information processed by qubits, allowing complex quantum algorithms to be executed reliably. They serve as the quantum analog of classical memory registers, providing the necessary storage and retrieval functions for quantum data.

Quantum Error Correction (116G) encompasses techniques for correcting errors in quantum computations. Quantum error correction includes redundant encoding, error detection, and correction gates to protect quantum information from decoherence and other quantum noise. These techniques are essential for maintaining the integrity of quantum computations, as quantum systems are highly sensitive to external disturbances. Without effective error correction, quantum information can quickly degrade, leading to incorrect results. Quantum error correction codes, such as the Shor code and the surface code, are designed to detect and correct errors in quantum states, ensuring the reliable execution of quantum algorithms.

Quantum Oracle (116H) is a function used for querying quantum algorithms and obtaining specific outputs. Oracles are used in algorithms like Grover's algorithm to evaluate the solution space efficiently. They provide a way to encode information about the problem being solved and are queried during the execution of the algorithm to guide the search for the correct solution. For instance, in Grover's algorithm, the oracle marks the correct solution by flipping its phase, allowing the algorithm to amplify the probability of the correct solution through quantum interference.

In summary, the Quantum Algorithms module (116) utilizes a combination of qubits, quantum gates, quantum circuits, superposition, quantum interferences, quantum registers, quantum error correction, and quantum oracles to process data in ways that are far more powerful and efficient than classical methods. Qubits enable the representation of multiple states simultaneously, while quantum gates and circuits implement the operations required for quantum algorithms. Superposition and interference allow parallel processing and the amplification of correct solutions. Quantum registers provide the necessary storage for qubits, and quantum error correction ensures the reliability of computations. Quantum oracles facilitate efficient querying and problem-solving. By leveraging these advanced quantum techniques, the module enhances the overall computational capabilities of the system, enabling it to solve complex problems more quickly and accurately.

Finally, the output from the quantum algorithms is as Result Data (118). This is a compilation of the final processed data and presents it as the output, ready for interpretation and decision-making. Sample quantum algorithms include Shor's Algorithm for factoring large integers, Grover's Algorithm for searching unsorted databases, Quantum Approximate Optimization Algorithm (QAOA) for solving combinatorial optimization problems, and Variational Quantum Eigensolver (VQE) for finding the lowest eigenvalue of a given Hamiltonian.

In summary, this detailed description encapsulates the entire process from raw data input to final results, explaining each component's role and its interaction with other elements within the multi-level algorithm engine. The integration of classical and quantum computing techniques ensures high-speed, accurate, and scalable data analysis. This approach is particularly valuable for applications requiring rapid and precise data analysis, such as finance, cybersecurity, and scientific research.

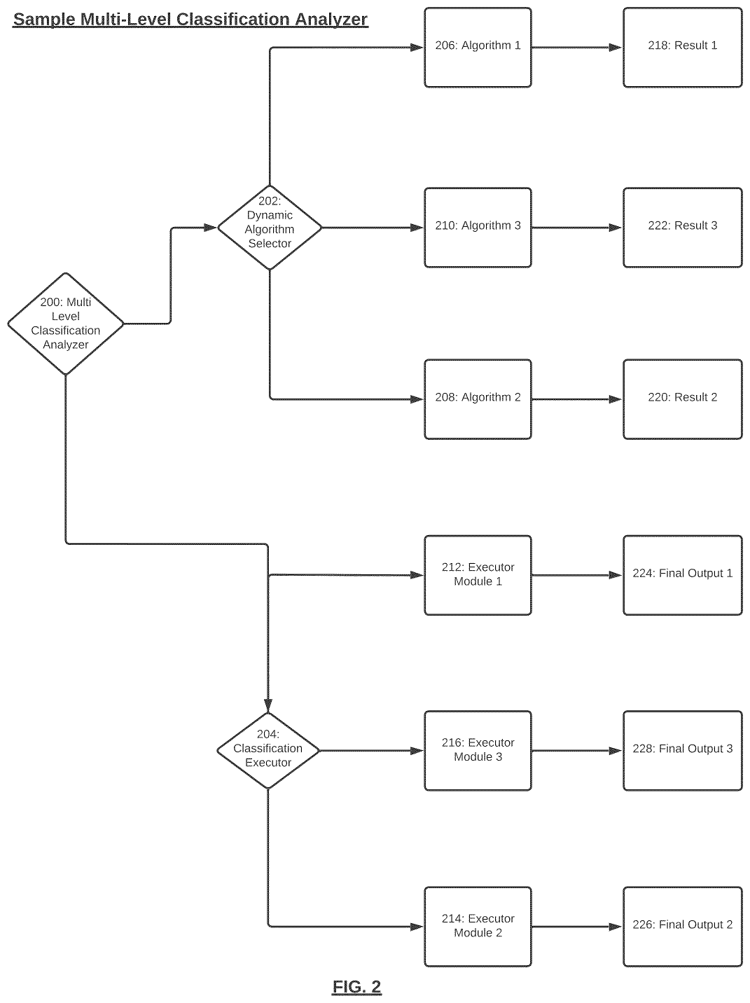

FIG. 2, by way of non-limiting disclosure, depicts the sample multi-level classification analyzer, which processes transactional data through a detailed and structured workflow to ensure accurate and efficient data classification and anomaly detection. The diagram depicts various components, each playing a crucial role in the overall process, beginning with the input of transactional data into the multi-level classification analyzer (200). This data is collected from multiple sources, such as financial transactions, sensor data, or user interactions, forming the foundation for the subsequent analysis.

The data then enters the dynamic algorithm selector (202). This component is responsible for evaluating a diverse pool of potential algorithms, including both classical machine learning methods and quantum algorithms. The selection process involves predefined criteria such as accuracy, efficiency, and relevance to the specific data characteristics. The dynamic algorithm selector adapts its choices based on real-time performance metrics, ensuring that the most suitable algorithms are selected for the given dataset. This adaptability allows the system to respond to changes in data characteristics and maintain optimal performance.

Once the algorithms are selected, the classification executor (204) executes these algorithms to classify the data into different categories or detect anomalies. The classification executor can run multiple algorithms simultaneously or in sequence, depending on the requirements of the data and the complexity of the analysis. The simultaneous execution of multiple algorithms allows for efficient handling of large datasets by leveraging parallel processing. This parallel approach ensures that the system can process vast amounts of data quickly, while also providing a means to compare results from different algorithms in real-time.

In contrast, sequential execution creates a pipeline where the output of one algorithm serves as the input for another. This method is particularly useful when initial classifications or detections need to be refined by subsequent algorithms. The classification executor utilizes specific modules, designated as Executor Module 1 (212), Executor Module 2 (214), and Executor Module 3 (216), to apply the selected algorithms to the data. Each executor module is responsible for processing the data using its respective algorithm, generating initial results, which are labeled as Result 1 (218), Result 2 (220), and Result 3 (222).

These executor modules continuously monitor the performance of their algorithms, adjusting parameters as necessary to optimize accuracy and efficiency. Continuous monitoring involves calculating performance metrics such as accuracy, precision, recall, and F1 score to evaluate how well each algorithm is performing. This real-time adjustment capability allows the system to maintain high levels of performance, even as data characteristics change.

The initial results from each executor module represent the preliminary classifications or anomaly detections made by the algorithms. To ensure comprehensive analysis, these results are aggregated and further analyzed. Aggregation involves combining the outputs from the different executor modules, considering the strengths and weaknesses of each result. If multiple algorithms identify the same anomaly, the confidence in that detection increases. This aggregation process helps in forming a more robust analysis by weighing the reliability and relevance of each result, leading to more accurate overall findings.

The aggregated results are then processed further, which might include additional analysis such as deeper pattern recognition or predictive modeling. This stage ensures that all insights gained from the initial analysis are preserved and utilized effectively for more detailed examination. By integrating multiple analyses, the system can refine its findings and provide more precise and actionable insights.

Finally, the system generates the final outputs, labeled as Final Output 1 (224), Final Output 2 (226), and Final Output 3 (228). These outputs are presented in a user-friendly format, such as charts, graphs, or reports, making it easy for users to interpret the findings and make informed decisions. The final outputs summarize the comprehensive analysis performed by the multi-level classification analyzer, providing actionable insights based on the processed data. This presentation ensures that stakeholders can understand the results clearly and use them to inform strategic decisions.

In conclusion, FIG. 2 demonstrates a comprehensive and structured approach to data classification and anomaly detection using a multi-level classification analyzer. The system dynamically selects and executes a variety of algorithms, leveraging both classical and quantum computing techniques. By continuously monitoring performance and adjusting parameters, the analyzer ensures accurate and efficient results. The process involves multiple stages, from data input and algorithm selection to execution, aggregation, further analysis, and final output presentation, offering a robust solution for complex data analysis tasks. The detailed workflow depicted in the figure showcases the system's ability to handle large datasets, adapt to changing data characteristics, and provide reliable and actionable insights.

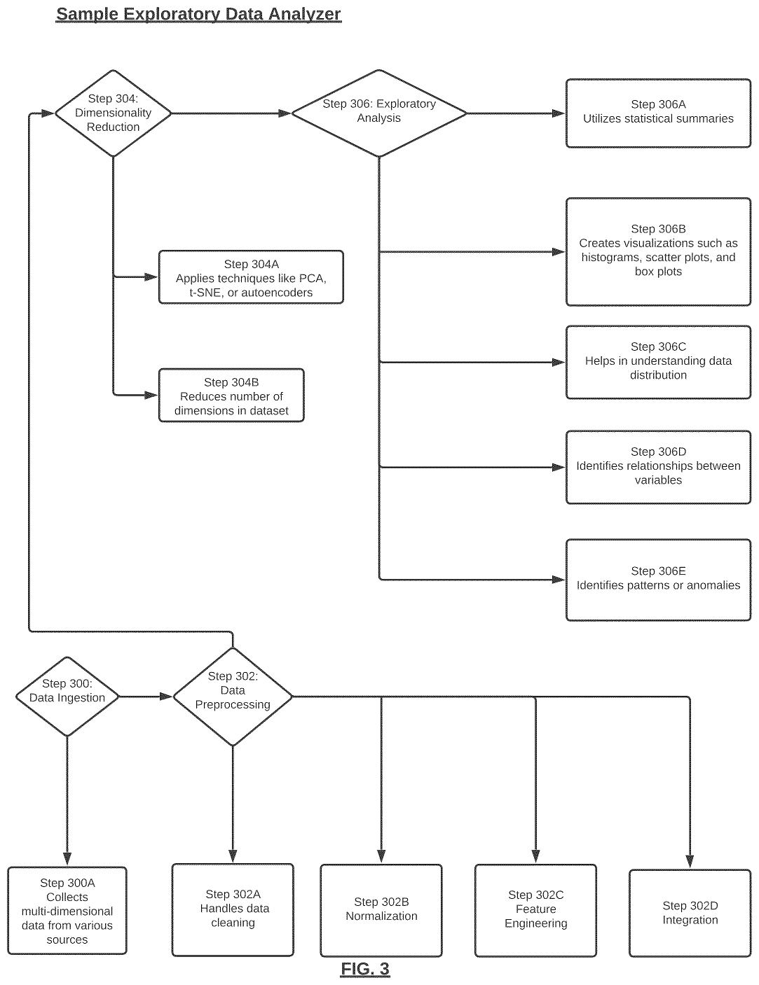

FIG. 3, by way of non-limiting disclosure, illustrates a sample exploratory data analyzer, a sophisticated system designed to process and analyze multi-dimensional data through a series of well-defined steps. Each step is crafted to handle specific aspects of data preparation and analysis, ensuring that the final insights are both accurate and actionable.

The process begins with data ingestion, which is the first step in the workflow. In this step, the system collects multi-dimensional data from various sources, aggregating information from databases, external data feeds, sensors, and user-generated inputs. This step ensures that the system has access to a comprehensive and diverse dataset, which is essential for robust analysis. The data ingestion process involves extracting data from different formats and structures, transforming it into a unified format that can be easily processed by the subsequent steps.

Following data ingestion, the data undergoes a rigorous preprocessing phase. This phase is divided into several tasks, each aimed at preparing the data for in-depth analysis. The first task in data preprocessing is data cleaning. Data cleaning involves identifying and correcting errors, inconsistencies, and missing values within the dataset. This task is critical because inaccurate or incomplete data can lead to erroneous conclusions. Techniques such as imputation for missing values, outlier detection, and correction of data entry errors are commonly employed to enhance the quality of the data.

Normalization is the next task in the preprocessing phase. Normalization scales the data to a standard range, eliminating discrepancies due to different units of measurement. For example, financial data in dollars and sensor data in degrees Celsius are brought to a common scale, making the data more comparable and easier to analyze. This task ensures that no single feature dominates the analysis due to its scale, thereby providing a balanced approach to data interpretation.

Feature engineering follows normalization. This task involves creating new features from the existing data that can enhance the predictive power of the algorithms used in the analysis. Feature engineering can include generating interaction terms, polynomial features, and domain-specific variables that capture important patterns and relationships within the data. For instance, in a financial dataset, creating features that represent the interaction between different financial indicators can provide deeper insights into market trends.

The final task in the preprocessing phase is data integration. This task involves combining data from multiple sources into a cohesive dataset. Data integration ensures consistency across different data sources, resolving any conflicts and creating a unified dataset that reflects a comprehensive view of the data landscape. This task might involve merging datasets, handling duplicate records, and aligning data formats to ensure seamless integration.

After preprocessing, the process moves to dimensionality reduction. Dimensionality reduction simplifies the data while retaining its essential features, making it easier to analyze. The first task in this step is applying advanced techniques such as Principal Component Analysis (PCA), t-Distributed Stochastic Neighbor Embedding (t-SNE), or autoencoders. PCA transforms the data into a set of linearly uncorrelated variables called principal components, capturing the most variance in the data with the fewest number of components. This technique helps in identifying the directions in which the data varies the most and projecting the data onto these directions to reduce its dimensions.

t-SNE is used for visualizing high-dimensional data by converting similarities between data points into joint probabilities and minimizing the divergence between these joint probabilities in a lower-dimensional space. This method is particularly useful for creating two or three-dimensional maps of high-dimensional datasets, allowing for easier visualization and interpretation. Autoencoders, which are neural networks, learn to compress the data into a lower-dimensional representation and then reconstruct it, capturing the most important features and patterns in the process.

The second task in dimensionality reduction is reducing the number of dimensions in the dataset. This task ensures that the reduced-dimensionality dataset retains the most critical information, making the subsequent analysis more manageable and focused on the most informative aspects of the data. Dimensionality reduction helps in mitigating the curse of dimensionality, improving the performance of machine learning algorithms by removing redundant and irrelevant features.

Once the data is preprocessed and its dimensions are reduced, the process moves to exploratory analysis. Exploratory analysis is the phase where the preprocessed and dimensionally reduced data is analyzed to uncover patterns, relationships, and anomalies. The first task in this phase is utilizing statistical summaries to provide a basic understanding of the data distribution. Statistical summaries include measures of central tendency (mean, median, mode), measures of variability (standard deviation, variance), and measures of distribution shape (skewness, kurtosis). These summaries offer insights into the overall characteristics of the dataset, helping to identify any deviations from the norm.

The next task in exploratory analysis is creating visualizations such as histograms, scatter plots, and box plots. Histograms show the frequency distribution of variables, allowing analysts to see how values are distributed across different ranges. Scatter plots illustrate the relationships between two variables, highlighting potential correlations or patterns. Box plots provide a summary of the data distribution, showing the median, quartiles, and potential outliers. These visual tools help in understanding the distribution of individual variables and the relationships between them, making it easier to identify patterns and trends.

Understanding data distribution is another task in exploratory analysis. By visually representing the statistical summaries, analysts can quickly grasp the distribution characteristics of the data, identifying any deviations or unusual patterns. This task helps in detecting skewness, kurtosis, and other distribution properties that might affect the analysis.

Identifying relationships between variables is essential for uncovering correlations and dependencies that might not be evident through numerical summaries alone. This task involves analyzing the visualizations and statistical summaries to detect any patterns or trends that indicate how variables interact with each other. Understanding these relationships is crucial for building predictive models and making informed decisions.

The final task in exploratory analysis is identifying patterns or anomalies within the data. Anomalies are data points that deviate significantly from the norm, which could indicate errors, outliers, or significant events that require further investigation. Patterns, on the other hand, are recurring trends or regularities within the data that can provide valuable insights for predictive modeling and decision-making. By identifying these patterns and anomalies, analysts can gain a deeper understanding of the data and uncover insights that might not be immediately apparent.

In summary, FIG. 3 depicts a detailed and structured process of exploratory data analysis using a sample exploratory data analyzer. The system handles data ingestion, preprocessing, dimensionality reduction, and exploratory analysis in a systematic manner, leveraging advanced techniques and visual tools to transform raw data into actionable insights. By following these steps, the exploratory data analyzer ensures that the data is clean, standardized, simplified, and thoroughly analyzed, providing a robust foundation for more detailed and accurate data analysis. This comprehensive approach enables the identification of key patterns, relationships, and anomalies, facilitating informed decision-making based on reliable and well-processed data.

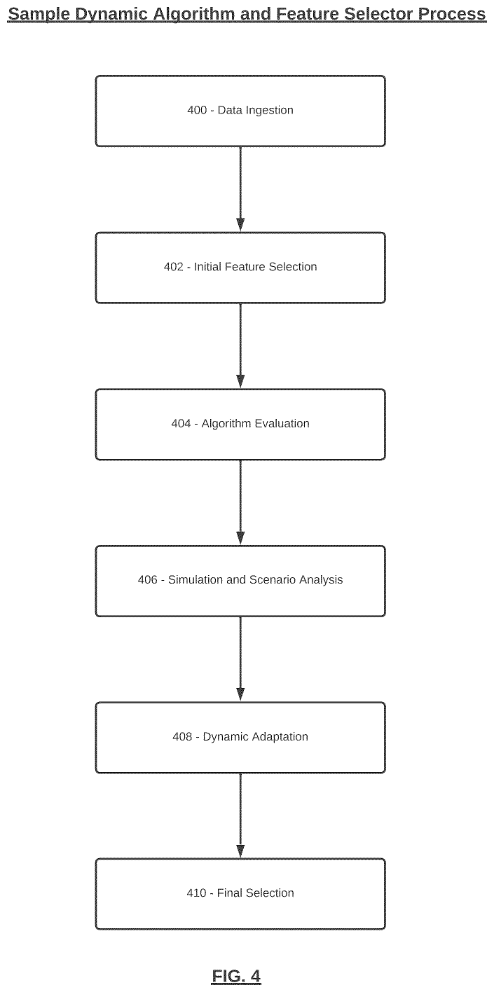

FIG. 4, by way of non-limiting disclosure, depicts a sample dynamic algorithm and feature selector process, detailing a comprehensive and methodical approach to optimizing both algorithm and feature selection for data analysis. Each step in the process plays a role in ensuring that the system selects the most relevant and effective algorithms and features, thereby enhancing the overall accuracy and efficiency of the analysis.

The process begins with data ingestion (400). During this step, the system collects raw data from various sources, such as databases, external data feeds, sensors, and user-generated inputs. The primary objective of data ingestion is to gather all pertinent information into a centralized repository, ensuring that the exploratory data analyzer has access to a comprehensive dataset for subsequent processing. Data ingestion involves extracting data from different formats and structures and transforming it into a unified format that can be easily processed by the subsequent steps. This transformation ensures that the data is in a consistent and accessible format, ready for detailed analysis.

Following data ingestion, the system proceeds to initial feature selection (402). In this step, the system identifies the most relevant features from the raw data that are likely to have the greatest impact on the analysis. Feature selection reduces the dimensionality of the data, eliminating redundant and irrelevant features that can complicate the analysis and degrade model performance. Techniques such as statistical tests, correlation analysis, and feature importance scores are used to evaluate and select the most significant features. By focusing on the most informative aspects of the data, initial feature selection helps streamline the analysis process and improves the performance of the selected algorithms. This task involves evaluating the contribution of each feature to the predictive power of the model and selecting only those features that provide meaningful insights.

Once the initial features have been selected, the process moves to algorithm evaluation (404). During this step, the system evaluates a diverse pool of potential algorithms, including both classical machine learning methods and quantum algorithms. The evaluation process involves assessing each algorithm based on predefined criteria such as accuracy, efficiency, and relevance to the specific data characteristics. The system uses historical performance data and benchmark tests to profile each algorithm, providing a benchmark for expected performance. This step ensures that the algorithms selected for further analysis are well-suited to the dataset and the analysis task. The evaluation process is thorough and systematic, considering various metrics and performance indicators to identify the best algorithms for the given task.

After evaluating the algorithms, the process moves to simulation and scenario analysis (406). In this step, the system performs data simulation and scenario analysis to predict the performance of the selected algorithms under different conditions. Simulators create synthetic datasets that mimic the characteristics of the real data, allowing the system to test how the algorithms perform in various scenarios. This step helps in identifying potential issues and optimizing the algorithms' performance, ensuring they are well-suited to the specific analysis task. Scenario analysis involves exploring different hypothetical situations to understand how the algorithms will behave under various conditions, providing insights into their robustness and reliability. This task involves creating detailed simulations that replicate real-world conditions, allowing the system to evaluate the algorithms' performance in a controlled environment.

The next step is dynamic adaptation (408), where the system continuously monitors the performance of the selected algorithms and makes real-time adjustments to optimize their performance. This step involves adjusting algorithm parameters, switching algorithms, or incorporating new features based on real-time performance metrics. Dynamic adaptation ensures that the system remains flexible and responsive to changes in data characteristics, maintaining optimal performance throughout the analysis process. This adaptability handles dynamic environments where data characteristics may evolve over time. The system uses continuous feedback loops to monitor performance and make necessary adjustments, ensuring that the algorithms remain effective and efficient.

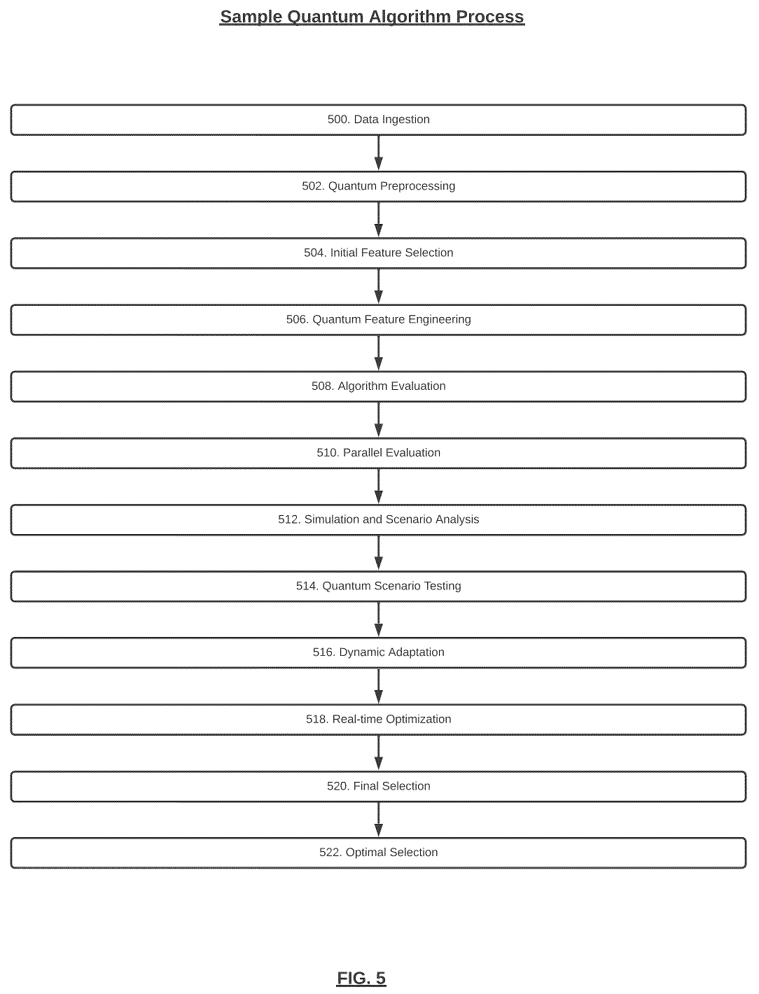

The final step in the process is final selection (410), where the system makes the final choice of algorithms and features for the analysis. This step involves synthesizing the results from the FIG. 5, by way of non-limiting disclosure, depicts previous steps, considering the performance of the algorithms and the relevance of the features. The system combines the outputs from the different evaluation and simulation stages, weighing the reliability and relevance of each result to make an informed final selection. The chosen algorithms and features are then used to perform the actual data analysis, providing accurate and reliable results.

Expanding on each step in more detail, the initial phase of data ingestion (400) is crucial as it sets the foundation for the entire process. During this phase, the system gathers data from diverse sources, ensuring a wide variety of information is captured. This could include structured data from databases, unstructured data from text documents, real-time data from sensors, and semi-structured data from web services. The ingestion process involves not only collecting this data but also transforming it into a standardized format, such as converting different date formats into a unified format or standardizing units of measurement. This transformation is essential for ensuring consistency and comparability across the dataset, which is critical for subsequent analysis steps.

In the initial feature selection phase (402), the system uses advanced statistical techniques to identify features that are most likely to impact the analysis. This phase is essential for reducing the dimensionality of the data, which helps to eliminate noise and irrelevant features that can obscure meaningful patterns. Techniques like Pearson correlation, mutual information, and chi-square tests are commonly used to evaluate the importance of each feature. By selecting the most relevant features, the system ensures that the analysis is focused on the most informative aspects of the data, enhancing the predictive power of the models used in the subsequent steps.

During algorithm evaluation (404), the system undertakes a comprehensive assessment of various algorithms. This involves running benchmark tests to compare the performance of different algorithms on historical data, using metrics such as accuracy, precision, recall, F1 score, and computational efficiency. The system profiles each algorithm to understand its strengths and weaknesses, considering factors like the complexity of the algorithm, its suitability for different types of data, and its ability to handle large datasets. This thorough evaluation ensures that only the most suitable algorithms are selected for further analysis.

In the simulation and scenario analysis phase (406), the system creates synthetic datasets that replicate the characteristics of the real data. These synthetic datasets are used to simulate various scenarios, testing how the selected algorithms perform under different conditions. This step is crucial for identifying potential issues, such as overfitting or underfitting, and optimizing the algorithms' performance. Scenario analysis involves exploring different hypothetical situations, such as changes in data distribution or the introduction of new variables, to understand how the algorithms will behave. This phase provides valuable insights into the robustness and reliability of the algorithms, ensuring they are well-suited for real-world applications.

Dynamic adaptation (408) is a continuous process where the system monitors the performance of the selected algorithms in real-time and adjusts as needed. This involves fine-tuning algorithm parameters, switching algorithms if necessary, and incorporating new features based on real-time performance metrics. The system uses feedback loops to continuously monitor performance and make necessary adjustments, ensuring that the algorithms remain effective and efficient. This adaptability is essential for handling dynamic environments where data characteristics may evolve over time, such as in financial markets or sensor networks.

The final selection phase (410) synthesizes the results from the previous steps, combining the outputs from the different evaluation and simulation stages. The system weighs the reliability and relevance of each result to make an informed final selection of algorithms and features. This step ensures that the chosen algorithms and features are the most suitable for the analysis task at hand, providing accurate and reliable results. The final selection is then used to perform the actual data analysis, leveraging the chosen algorithms and features to extract meaningful insights from the data.

In conclusion, FIG. 4 depicts a detailed and structured process for dynamic algorithm and feature selection. The system begins with data ingestion, followed by initial feature selection to identify the most relevant features. Algorithm evaluation assesses a diverse pool of algorithms, followed by simulation and scenario analysis to predict their performance. Dynamic adaptation ensures real-time optimization, and the final selection synthesizes all the results to choose the most effective algorithms and features for the analysis. This comprehensive approach enhances the overall accuracy and efficiency of the data analysis, providing a robust solution for complex data analysis tasks. Each step in the process is meticulously designed to ensure that the system selects the most relevant and effective algorithms and features, thereby delivering accurate and reliable results.

FIG. 5, by way of non-limiting disclosure, illustrates a sample quantum algorithm process, a detailed and structured approach designed to leverage the capabilities of quantum computing for data analysis. This process ensures that data is optimally prepared and analyzed using advanced quantum algorithms, providing significant computational advantages. Each step in this process is designed to handle specific aspects of data preparation and analysis, ensuring that the final results are accurate and reliable.

The process begins with data ingestion (500). During this initial step, the system collects raw data from various sources, including databases, external data feeds, sensors, and user-generated inputs. The primary objective of data ingestion is to gather all relevant information into a centralized repository, ensuring that the system has access to a comprehensive dataset for further processing. This step involves extracting data from different formats and structures, transforming it into a unified format that can be easily processed in subsequent steps. Data ingestion ensures that the raw data is available in a consistent and accessible format, ready for detailed analysis.

Following data ingestion, the next step is quantum preprocessing (502). In this step, the data undergoes initial preparation tailored specifically for quantum computing. Quantum preprocessing involves several tasks such as data cleaning, normalization, and encoding classical data into a format suitable for quantum algorithms. Data cleaning identifies and corrects errors, inconsistencies, and missing values within the dataset, ensuring the data's accuracy and reliability. Normalization scales the data to a standard range, eliminating discrepancies due to different units of measurement, and encoding transforms classical data into quantum states using techniques like quantum gates. This preprocessing step ensures that the data is properly formatted and ready for quantum feature selection and engineering.

The process then moves to initial feature selection (504). In this step, the system identifies the most relevant features from the raw data that are likely to have the greatest impact on the analysis. Feature selection reduces the dimensionality of the data, eliminating redundant and irrelevant features that can complicate the analysis and degrade model performance. Techniques such as statistical tests, correlation analysis, and feature importance scores are used to evaluate and select the most significant features. By focusing on the most informative aspects of the data, initial feature selection helps streamline the analysis process and improves the performance of the selected algorithms.

Quantum feature engineering (506) follows initial feature selection. This step involves creating new features from the existing data that can enhance the predictive power of the quantum algorithms used in the analysis. Quantum feature engineering utilizes the principles of quantum mechanics, such as superposition and entanglement, to generate features that capture complex patterns and relationships within the data. This process might involve creating interaction terms, polynomial features, or domain-specific variables that provide additional insights. By leveraging quantum mechanics, this step enhances the ability of the algorithms to detect subtle and complex patterns in the data.

Algorithm evaluation (508) is the next step in the process. During this step, the system evaluates a diverse pool of potential quantum algorithms. The evaluation process involves assessing each algorithm based on predefined criteria such as accuracy, efficiency, and relevance to the specific data characteristics. The system uses historical performance data and benchmark tests to profile each algorithm, providing a benchmark for expected performance. This thorough evaluation ensures that the algorithms selected for further analysis are well-suited to the dataset and the analysis task.

Parallel evaluation (510) follows algorithm evaluation. In this step, the selected quantum algorithms are executed in parallel, allowing the system to process large datasets efficiently and compare the performance of different algorithms in real-time. Parallel execution leverages the computational power of quantum systems to handle vast amounts of data simultaneously, significantly reducing processing time and enhancing the accuracy of the analysis.

Simulation and scenario analysis (512) is the next step. This step involves creating synthetic datasets that mimic the characteristics of the real data and performing scenario analysis to predict the performance of the selected algorithms under different conditions. Simulators create synthetic datasets that replicate real-world data characteristics, allowing the system to test how the algorithms perform in various scenarios. Scenario analysis explores different hypothetical situations to understand how the algorithms will behave under various conditions, providing insights into their robustness and reliability.

Quantum scenario testing (514) follows simulation and scenario analysis. In this step, the system conducts detailed tests of the quantum algorithms under various simulated scenarios. Quantum scenario testing helps identify potential issues, optimize algorithm performance, and ensure that the algorithms are well-suited for real-world applications. This step involves using quantum-specific techniques to test the algorithms' robustness and reliability in different scenarios.

Dynamic adaptation (516) is a continuous process where the system monitors the performance of the selected quantum algorithms in real-time and adjusts as needed. This step involves fine-tuning algorithm parameters, switching algorithms if necessary, and incorporating new features based on real-time performance metrics. Dynamic adaptation ensures that the system remains flexible and responsive to changes in data characteristics, maintaining optimal performance throughout the analysis process.

Real-time optimization (518) involves continuously optimizing the selected quantum algorithms to ensure they deliver the best possible performance. This step involves real-time adjustments to algorithm parameters, selection criteria, and feature sets based on ongoing performance monitoring. Real-time optimization ensures that the algorithms remain effective and efficient, providing accurate and reliable results.

The final selection (520) synthesizes the results from the previous steps, combining the outputs from the different evaluation, simulation, and testing stages. The system weighs the reliability and relevance of each result to make an informed final selection of quantum algorithms and features. This step ensures that the chosen algorithms and features are the most suitable for the analysis task at hand, providing accurate and reliable results.

Optimal selection (522) represents the culmination of the entire process. This final step involves selecting the most effective combination of quantum algorithms and features for the given data analysis task. The optimal selection is based on a comprehensive evaluation of performance metrics, simulation results, scenario testing, and real-time optimization. The chosen algorithms and features are then used to perform the actual data analysis, leveraging the computational power of quantum systems to extract meaningful insights from the data.

Expanding on each step in more detail, the initial phase of data ingestion (500) is crucial as it sets the foundation for the entire process. During this phase, the system gathers data from diverse sources, ensuring a wide variety of information is captured. This could include structured data from databases, unstructured data from text documents, real-time data from sensors, and semi-structured data from web services. The ingestion process involves not only collecting this data but also transforming it into a standardized format, such as converting different date formats into a unified format or standardizing units of measurement. This transformation is essential for ensuring consistency and comparability across the dataset, which is critical for subsequent analysis steps.

In quantum preprocessing (502), the system performs tasks specifically tailored for preparing data for quantum algorithms. Data cleaning in this context involves identifying and correcting errors, inconsistencies, and missing values within the dataset. This ensures that the data is accurate and reliable for subsequent quantum processing. Normalization scales the data to a standard range, which helps eliminate discrepancies due to different units of measurement. Encoding classical data into quantum states is a critical part of this step. This involves using quantum gates to represent classical data in a form that can be processed by quantum computers. This encoding process is essential for leveraging the full computational power of quantum algorithms.

Initial feature selection (504) involves identifying the most relevant features from the raw data. Techniques such as statistical tests, correlation analysis, and feature importance scores are used to evaluate and select the most significant features. Feature selection reduces the dimensionality of the data, eliminating redundant and irrelevant features that can complicate the analysis and degrade model performance. This step ensures that the analysis is focused on the most informative aspects of the data, enhancing the predictive power of the models used in the subsequent steps.

Quantum feature engineering (506) leverages the principles of quantum mechanics to create new features from the existing data. This process involves using quantum operations such as superposition and entanglement to generate features that capture complex patterns and relationships within the data. For example, quantum entanglement can create correlations between features that are not evident in classical data. This step enhances the ability of quantum algorithms to detect subtle and complex patterns, improving the overall accuracy of the analysis.

Algorithm evaluation (508) involves a thorough assessment of various quantum algorithms. The system evaluates each algorithm based on predefined criteria such as accuracy, efficiency, and relevance to the specific data characteristics. Historical performance data and benchmark tests are used to profile each algorithm, providing a benchmark for expected performance. This evaluation ensures that only the most suitable algorithms are selected for further analysis

Parallel evaluation (510) leverages the computational power of quantum systems to process large datasets efficiently. By executing multiple algorithms in parallel, the system can handle vast amounts of data simultaneously, significantly reducing processing time. This step also allows for real-time comparison of different algorithms, ensuring that the best performing algorithms are identified quickly.

Simulation and scenario analysis (512) involves creating synthetic datasets that replicate the characteristics of the real data. These synthetic datasets are used to test how the selected algorithms perform under various scenarios. This step helps identify potential issues and optimize the algorithms' performance. Scenario analysis explores different hypothetical situations, such as changes in data distribution or the introduction of new variables, to understand how the algorithms will behave. This step provides valuable insights into the robustness and reliability of the algorithms.

Quantum scenario testing (514) involves conducting detailed tests of the quantum algorithms under various simulated scenarios. This step helps identify potential issues, optimize algorithm performance, and ensure that the algorithms are well-suited for real-world applications. Quantum-specific techniques are used to test the algorithms' robustness and reliability in different scenarios.

Dynamic adaptation (516) is a continuous process where the system monitors the performance of the selected quantum algorithms in real-time and adjusts as needed. This step involves fine-tuning algorithm parameters, switching algorithms if necessary, and incorporating new features based on real-time performance metrics. Dynamic adaptation ensures that the system remains flexible and responsive to changes in data characteristics, maintaining optimal performance throughout the analysis process.

Real-time optimization (518) involves continuously optimizing the selected quantum algorithms to ensure they deliver the best possible performance. This step involves real-time adjustments to algorithm parameters, selection criteria, and feature sets based on ongoing performance

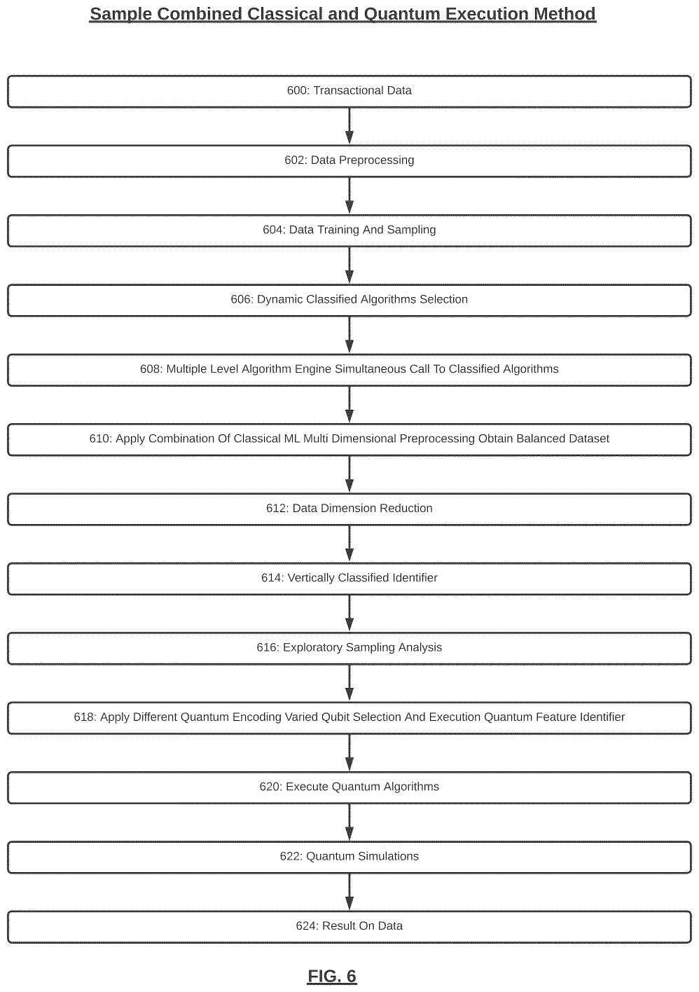

FIG. 6, byway of non-limiting disclosure, illustrates the sample combined classical and quantum execution method, detailing a comprehensive and integrated approach that leverages both classical machine learning (ML) techniques and quantum computing capabilities for advanced data analysis. This method ensures that data is optimally processed and analyzed, taking full advantage of the strengths of both classical and quantum approaches. Each step in this process is meticulously designed to handle specific aspects of data preparation and analysis, ensuring the final results are accurate and insightful.

The process begins with the collection of transactional data (600). During this initial step, the system collects raw data from various sources such as databases, external data feeds, sensors, and user-generated inputs. The primary objective of data ingestion is to gather all relevant information into a centralized repository, ensuring that the system has access to a comprehensive dataset for further processing. This step involves extracting data from different formats and structures and transforming it into a unified format that can be easily processed in subsequent steps. Data ingestion ensures that the raw data is available in a consistent and accessible format, ready for detailed analysis.

Following data ingestion, the next step is data preprocessing (602). In this step, the data undergoes initial preparation to ensure it is clean and standardized for detailed analysis. Data preprocessing involves several tasks, including data cleaning, normalization, and initial feature selection. Data cleaning identifies and corrects errors, inconsistencies, and missing values within the dataset, ensuring the data's accuracy and reliability. Normalization scales the data to a standard range, eliminating discrepancies due to different units of measurement, making the data more comparable. Initial feature selection identifies the most relevant features, reducing the dimensionality of the data and focusing the analysis on the most informative aspects. These preprocessing steps ensure that the data entering the system is clean, standardized, and ready for further processing.

Once the data is preprocessed, the next step is data training and sampling (604). In this step, the dataset is divided into training and testing sets, which are used to train and evaluate the selected algorithms. Sampling techniques, such as stratified sampling, ensure that the training and testing sets are representative of the overall dataset, maintaining the balance and diversity of the data. Training the algorithms on these representative samples allows for the development of models that generalize well to new, unseen data, ensuring robust and reliable performance.

The process then moves to dynamic classified algorithms selection (606). In this step, the system evaluates and selects the most suitable algorithms for the analysis. This involves assessing a diverse pool of classical ML algorithms and quantum algorithms based on predefined criteria such as accuracy, efficiency, and relevance to the specific data characteristics. The system dynamically adapts its choices based on real-time performance metrics, ensuring that the most effective algorithms are selected for further analysis. This step involves continuous evaluation and adaptation, allowing the system to respond to changes in data characteristics and maintain optimal performance.

Following the selection of algorithms, the multiple level algorithm engine simultaneously calls the classified algorithms (608). This step involves executing the selected algorithms in parallel, allowing the system to process large datasets efficiently and compare the performance of different algorithms in real-time. Parallel execution leverages the computational power of both classical and quantum systems, significantly reducing processing time and enhancing the accuracy of the analysis. This simultaneous execution ensures that the system can handle vast amounts of data quickly while also providing a means to compare results from different algorithms and select the best performing ones.

In the next step, a combination of classical ML multi-dimensional preprocessing (including Generative AI or the like) is applied to obtain a balanced dataset (610). This involves using classical ML techniques to preprocess the data further, ensuring that it is well-prepared for dimensionality reduction and quantum processing. Techniques such as feature scaling, normalization, and transformation are used to create a balanced dataset that maintains the integrity and variability of the original data. This step is crucial for preparing the data for subsequent analysis, ensuring that it is in an optimal state for further processing.

Data dimension reduction (612) follows, where advanced techniques such as Principal Component Analysis (PCA), t-Distributed Stochastic Neighbor Embedding (t-SNE), and autoencoders are applied to reduce the number of dimensions in the dataset. Dimensionality reduction simplifies the data while retaining its essential features, making it easier to analyze and improving the performance of the subsequent quantum algorithms. PCA transforms the data into a set of linearly uncorrelated variables, capturing the most variance with the fewest components. t-SNE is used for visualizing high-dimensional data by reducing it to two or three dimensions, making it easier to interpret. Autoencoders, which are neural networks, learn efficient encodings by compressing the data into a lower-dimensional representation.

The vertically classified identifier (614) is then applied to categorize the data based on its reduced dimensions. This step involves using classification algorithms to assign labels or categories to the data, creating a structured and organized dataset that is ready for exploratory sampling analysis. The vertically classified identifier ensures that the data is properly categorized, making it easier to analyze and interpret.

Exploratory sampling analysis (616) is conducted to uncover patterns, relationships, and anomalies within the data. This step involves using statistical summaries, visualizations, and exploratory data analysis techniques to gain a deeper understanding of the data's characteristics. The insights gained from this analysis are used to inform the subsequent quantum processing steps. Exploratory sampling analysis helps in identifying significant patterns and trends that might not be immediately apparent, providing valuable insights for further analysis.

Next, different quantum encoding methods and varied qubit selection are applied, along with the execution of the quantum feature identifier (618). This step involves encoding the preprocessed data into quantum states using various quantum gates and operations. The selection of qubits and encoding methods is optimized to capture the most relevant features and patterns within the data, enhancing the performance of the quantum algorithms. This step leverages the full computational power of quantum algorithms, ensuring that the data is encoded in a way that maximizes the efficiency and effectiveness of the subsequent analysis.

The quantum algorithms are then executed (620). This involves running the selected quantum algorithms on the encoded data to perform advanced computations and analysis. Quantum algorithms leverage the principles of superposition and entanglement to process data more efficiently than classical algorithms, providing significant computational advantages. This step involves using quantum-specific techniques to perform complex calculations that would be infeasible with classical computing alone.

Quantum simulations (622) follow, where the system conducts detailed simulations of the quantum algorithms under various scenarios. This step helps identify potential issues, optimize algorithm performance, and ensure that the algorithms are well-suited for real-world applications. Quantum-specific techniques are used to test the algorithms' robustness and reliability in different scenarios, providing insights into their performance under various conditions.

The process concludes with the generation of results on data (624). The final results are compiled and presented in a user-friendly format, such as charts, graphs, and reports, making it easy for users to interpret the findings and make informed decisions. The results summarize the comprehensive analysis performed by the combined classical and quantum execution method, providing actionable insights based on the processed data.

In summary, FIG. 6 depicts a detailed and integrated process for leveraging both classical and quantum computing techniques in data analysis. The system begins with transactional data collection and preprocessing, followed by data training and sampling, dynamic algorithm selection, and parallel execution of selected algorithms. Classical ML techniques are applied to preprocess and balance the dataset, followed by dimensionality reduction and classification. Exploratory sampling analysis uncovers patterns and anomalies, informing the subsequent quantum processing steps. Different quantum encoding methods and varied qubit selection are applied, followed by the execution of quantum algorithms and quantum simulations. The process concludes with the generation of results, providing a robust solution for complex data analysis tasks. Each step in the process is designed to ensure that the system leverages the strengths of both classical and quantum computing, delivering accurate, efficient, and insightful results. This comprehensive approach enhances the overall performance and reliability of the data analysis, making it suitable for a wide range of applications in finance, cybersecurity, and other fields.

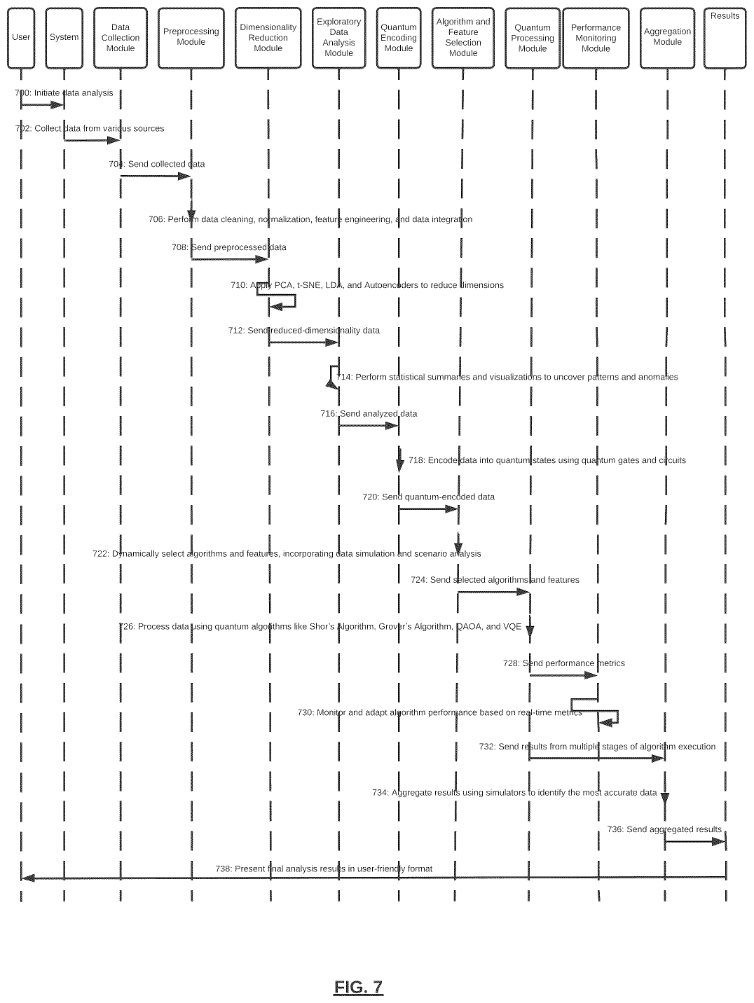

FIG. 7, by way of non-limiting disclosure, illustrates a detailed sequence diagram depicting the interaction between a user and various system modules in the multi-level quantum-based vertically classified entropy exploratory analytics system. The process begins with the user initiating the data analysis (700). The system's data collection module is then activated to collect multi-dimensional transactional data from various sources such as databases, sensors, and user interactions (702). This collected data is subsequently sent to the preprocessing module (704). Within the preprocessing module, several steps are performed, including data cleaning to identify and correct errors, inconsistencies, and missing values using imputation techniques; normalization to scale the data to a standard range; feature engineering to create new features such as interaction terms, polynomial features, and domain-specific variables; and data integration to merge datasets from multiple sources, resolve data conflicts, and ensure consistency across different data formats (706). The preprocessed data is then sent to the dimensionality reduction module (708).

In the dimensionality reduction module, various techniques are applied to the preprocessed dataset to obtain a reduced-dimensionality dataset. These techniques include Principal Component Analysis (PCA) to transform the data into a set of linearly uncorrelated variables called principal components, t-Distributed Stochastic Neighbor Embedding (t-SNE) to visualize high-dimensional data by converting similarities between data points into joint probabilities and minimizing divergence in a lower-dimensional space, Linear Discriminant Analysis (LDA) to project the data onto a lower-dimensional space where the classes are distinct, and Autoencoders to learn efficient encodings of the data, capturing the most important features and patterns (710). The reduced-dimensionality data is then sent to the exploratory data analysis module (712).

In the exploratory data analysis module, the system performs exploratory data analysis on the reduced-dimensionality dataset to uncover patterns, relationships, and anomalies (714). This step involves utilizing statistical summaries, including measures of central tendency, variability, and distribution shape, and creating visualizations such as histograms to show frequency distribution, scatter plots to illustrate relationships between variables, and box plots to provide a summary of the data distribution. These visualizations help in understanding the data distribution and identifying relationships between variables. The analyzed data is then sent to the quantum encoding module (716).

In the quantum encoding module, the system encodes the analyzed data into quantum states (718). This process leverages principles of quantum superposition and entanglement, employing quantum gates such as Hadamard gates for creating superposition, Pauli-X, Pauli-Y, and Pauli-Z gates for performing rotations on qubits, and CNOT (controlled-NOT) gates for entangling qubits, to transform the data into a quantum-compatible format using quantum circuits. The quantum-encoded data is then sent to the algorithm and feature selection module (720).

The algorithm and feature selection module dynamically selects the most suitable algorithms and features for the quantum-encoded data (722). This module incorporates data simulation to create synthetic datasets that mimic real data characteristics, scenario analysis to explore hypothetical situations, and adaptive selection processes to refine algorithm choices based on real-time performance metrics. The selected algorithms and features are then sent to the quantum processing module (724).

In the quantum processing module, the system processes the quantum-encoded data using quantum algorithms (726). These algorithms include Shor's Algorithm for factoring large integers, Grover's Algorithm for searching unsorted databases, Quantum Approximate Optimization Algorithm (QAOA) for solving combinatorial optimization problems, and Variational Quantum Eigensolver (VQE) for finding the lowest eigenvalue of a given Hamiltonian. These algorithms are executed through quantum circuits with qubits and quantum gates, leveraging superposition and quantum interferences to amplify correct solutions and diminish incorrect ones. The performance metrics of the selected algorithms are then sent to the performance monitoring module (728).

The performance monitoring module continuously monitors the performance of the selected algorithms and adapts them in real-time based on performance metrics such as accuracy, precision, recall, F1 score, and computational efficiency (730). This step involves adjusting algorithm parameters, switching algorithms, or incorporating new features as necessary to optimize their efficiency and accuracy. The results from multiple stages of algorithm execution are then sent to the aggregation module (732).

In the aggregation module, the system aggregates the results from multiple stages of algorithm execution, weighing the reliability and relevance of each result (734). This module uses multiple simulators to identify the most accurate data and combines them to form a comprehensive analysis, ensuring that only the best results are aggregated and analyzed further. The aggregated results are then sent to the results presentation module (736).

The results presentation module presents the final analysis results to the user in a user-friendly format (738). This presentation includes charts, graphs, and reports, ensuring accurate and comprehensive data insights for informed decision-making. The detailed sequence diagram in FIG. 7 provides a comprehensive overview of the step-by-step interaction between the user and the system, illustrating the intricate processes involved in multi-level quantum-based vertically classified entropy exploratory analytics.

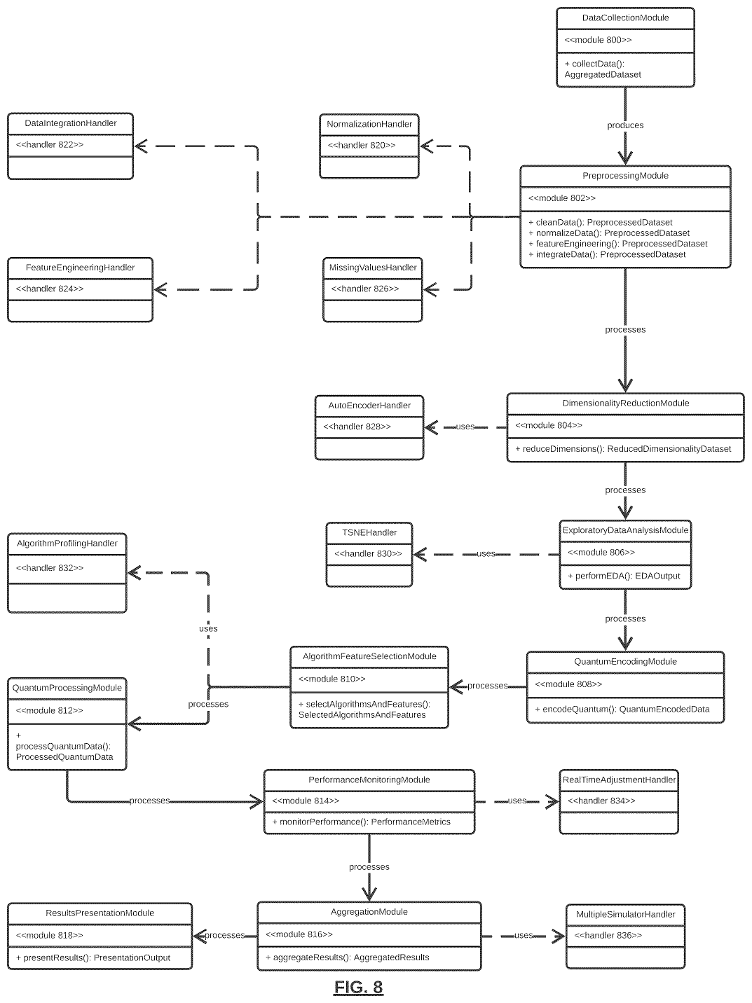

FIG. 8, by way of non-limiting disclosure, provides a sample class diagram that details the structure and functions of the system modules involved in the multi-level quantum-based vertically classified entropy exploratory analytics. The diagram delineates each module's specific methods and interactions, illustrating how data flows through the system and how each component contributes to the overall process.

The Data Collection Module (800) is configured to collect multi-dimensional transactional data from various sources, including databases, sensors, and user interactions. This module is responsible for aggregating the collected data into a unified dataset through its ‘collectData( )’ method, which produces an aggregated dataset for further processing.

The Preprocessing Module (802) performs several tasks to prepare the data for analysis. This module includes methods for ‘cleanData( )’, which involves identifying and correcting errors, inconsistencies, and missing values using imputation techniques; the ‘normalizeData( )’ method scales the data to a standard range, eliminating discrepancies due to different units of measurement. Feature engineering is carried out through the ‘featureEngineering( )’ method, which generates new features such as interaction terms, polynomial features, and domain-specific variables to enhance the predictive power of the algorithms. The ‘integrateData( )’ method merges datasets from multiple sources, resolves data conflicts, and ensures consistency across different data formats, producing a preprocessed dataset ready for dimensionality reduction. The module is further supported by several handlers: the Missing Values Handler (826), the Normalization Handler (820), the Feature Engineering Handler (824), and the Data Integration Handler (822).

The Dimensionality Reduction Module (804) applies techniques to the preprocessed dataset to reduce its dimensionality. This module includes methods such as ‘apply_PCA( )’ for transforming the data into a set of linearly uncorrelated variables called principal components, ‘apply_tSNE( )’ for visualizing high-dimensional data by converting similarities between data points into joint probabilities and minimizing divergence in a lower-dimensional space, ‘apply_LDA( )’ for projecting the data onto a lower-dimensional space where the classes are distinct, and ‘apply_Autoencoders( )’ for learning efficient encodings of the data, capturing the most important features and patterns. This module is further supported by the AutoEncoder Handler (828) and the TSNE Handler (830).

The Exploratory Data Analysis Module (806) is configured to perform exploratory data analysis on the reduced-dimensionality dataset. This module includes methods for ‘performEDA( )’, which involves generating statistical summaries including measures of central tendency, variability, and distribution shape. It also creates visualizations such as histograms to show frequency distribution, scatter plots to illustrate relationships between variables, and box plots to provide a summary of the data distribution. These visualizations help in understanding data distribution and identifying relationships between variables, producing EDAOutput.

The Quantum Encoding Module (808) encodes the analyzed data into quantum states. This module leverages principles of quantum superposition and entanglement, employing quantum gates such as Hadamard gates for creating superposition, Pauli-X, Pauli-Y, and Pauli-Z gates for performing rotations on qubits, and CNOT (controlled-NOT) gates for entangling qubits. The ‘encodeQuantum( )’ method transforms the data into a quantum-compatible format using quantum circuits, producing QuantumEncodedData.

The Algorithm and Feature Selection Module (810) dynamically selects the most suitable algorithms and features for the quantum-encoded data. This module incorporates methods such as ‘selectAlgorithmsAndFeatures( )’, which includes data simulation to create synthetic datasets that mimic real data characteristics, scenario analysis to explore hypothetical situations, and adaptive selection processes to refine algorithm choices based on real-time performance metrics. Profiling each algorithm based on historical performance on similar datasets provides a benchmark for expected performance, producing SelectedAlgorithmsAndFeatures. This module is further supported by the Algorithm Profiling Handler (832).

The Quantum Processing Module (812) processes the quantum-encoded data using quantum algorithms. This module includes methods such as ‘execute_Shors_Algorithm( )’ for factoring large integers using Shor's Algorithm, ‘execute_Grovers_Algorithm( )’ for searching unsorted databases using Grover's Algorithm, ‘execute_QAOA( )’ for solving combinatorial optimization problems using the Quantum Approximate Optimization Algorithm (QAOA), and ‘execute_VQE( )’ for finding the lowest eigenvalue of a given Hamiltonian using the Variational Quantum Eigensolver (VQE). These methods leverage superposition and quantum interferences to amplify correct solutions and diminish incorrect ones, producing ProcessedQuantumData.

The Performance Monitoring Module (814) continuously monitors the performance of the selected algorithms and adapts them in real-time based on performance metrics such as accuracy, precision, recall, F1 score, and computational efficiency. This module includes methods for ‘monitorPerformance( )’, ‘adapt_algorithms( )’, ‘adjust_parameters( )’, ‘switch_algorithms( )’, and ‘incorporate_new_features( )’, ensuring that the algorithms are optimized for efficiency and accuracy, producing PerformanceMetrics. This module is further supported by the Real-Time Adjustment Handler (834).

The Aggregation Module (816) aggregates the results from multiple stages of algorithm execution. This module includes methods such as ‘aggregateResults( )’, which weighs the reliability and relevance of each result, and ‘use_simulators( )’ to identify the most accurate data using multiple simulators. The results are combined to form a comprehensive analysis, ensuring that only the best results are aggregated and analyzed further, producing AggregatedResults. This module is further supported by the Multiple Simulator Handler (836).

Finally, the Results Presentation Module (818) presents the final analysis results to the user in a user-friendly format. This module includes methods for ‘presentResults( )’, which generates charts, graphs, and reports to ensure accurate and comprehensive data insights for informed decision-making, producing PresentationOutput.

The diagram in FIG. 8 effectively illustrates the intricate relationships and interactions between these modules, providing a clear understanding of how the system functions as a whole to perform advanced data analysis using quantum-based techniques.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for multi-level quantum-based vertically classified entropy exploratory analytics, comprising the steps of:
collecting multi-dimensional transactional data from various sources, including databases, sensors, and user interactions, to form an aggregated dataset;
preprocessing the data as collected by performing data cleaning, including identifying and correcting errors, inconsistencies, and missing values using imputation techniques, normalization to scale the data to a standard range, feature engineering to create new features such as interaction terms, polynomial features, and domain-specific variables, and data integration to merge datasets from multiple sources, resolve data conflicts, and ensure consistency across different data formats, to produce a preprocessed dataset;
applying dimensionality reduction techniques, including Principal Component Analysis (PCA) to transform the data into a set of linearly uncorrelated variables called principal components, t-Distributed Stochastic Neighbor Embedding (t-SNE) to visualize high-dimensional data by converting similarities between data points into joint probabilities and minimizing divergence in a lower-dimensional space, Linear Discriminant Analysis (LDA) to project the data onto a lower-dimensional space where the classes are distinct, and Autoencoders to learn efficient encodings of the data, capturing the most important features and patterns, to the preprocessed dataset to obtain a reduced-dimensionality dataset;
performing exploratory data analysis on the reduced-dimensionality dataset to uncover patterns, relationships, and anomalies, utilizing statistical summaries including measures of central tendency, variability, and distribution shape, and creating visualizations such as histograms to show frequency distribution, scatter plots to illustrate relationships between variables, and box plots to provide a summary of data distribution, to understand data distribution and identify relationships between variables;
encoding analyzed data into quantum states using a quantum encoder, leveraging principles of quantum superposition and entanglement, and employing quantum gates, including Hadamard gates for creating superposition, Pauli-X, Pauli-Y, and Pauli-Z gates for performing rotations on qubits, and CNOT (controlled-NOT) gates for entangling qubits, to transform the data into quantum-compatible format using quantum circuits;
dynamically selecting suitable algorithms and features for quantum-encoded data using an algorithm selector and a feature selector, incorporating data simulation to create synthetic datasets that mimic real data characteristics, scenario analysis to explore hypothetical situations, and adaptive selection processes to refine algorithm choices based on real-time performance metrics;
processing the quantum-encoded data using quantum algorithms, including Shor's Algorithm for factoring large integers, Grover's Algorithm for searching unsorted databases, Quantum Approximate Optimization Algorithm (QAOA) for solving combinatorial optimization problems, and Variational Quantum Eigensolver (VQE) for finding the lowest eigenvalue of a given Hamiltonian, executed through quantum circuits with qubits and quantum gates, leveraging superposition and quantum interferences to amplify correct solutions and diminish incorrect ones;
continuously monitoring the performance of the selected algorithms and adapting them in real-time based on performance metrics, including accuracy, precision, recall, F1 score, and computational efficiency, to optimize their efficiency and accuracy, adjusting algorithm parameters, switching algorithms, or incorporating new features as necessary;
aggregating results from multiple stages of algorithm execution, weighing reliability and relevance of each result, using multiple simulators to identify the most accurate data, and combining them to form a comprehensive analysis, ensuring that only optimum results are aggregated and analyzed further; and
presenting final analysis results in a user-friendly format, including charts, graphs, and reports, ensuring accurate and comprehensive data insights for informed decision-making.

2. The method of claim 1, further comprising the step of handling missing values in said preprocessing by employing imputation techniques to fill in missing data points.

3. The method of claim 2, wherein the normalization in said preprocessing involves scaling the data to a standard range, eliminating discrepancies due to different units of measurement.

4. The method of claim 3, wherein the feature engineering step in preprocessing includes generating interaction terms, polynomial features, and domain-specific variables to enhance predictive power of the algorithms.

5. The method of claim 4, wherein the data integration involves merging datasets from multiple sources, resolving data conflicts, and ensuring consistency across different data sources.

6. The method of claim 5, wherein the dimensionality reduction further comprises using autoencoders to learn efficient encodings of the data, capturing the most important features and patterns.

7. The method of claim 6, wherein the exploratory data analysis utilizes techniques such as t-SNE for visualizing high-dimensional data by converting similarities between data points into joint probabilities and minimizing the divergence between these joint probabilities in a lower-dimensional space.

8. The method of claim 7, wherein the dynamic selection of algorithms includes evaluating each algorithm based on historical performance on similar datasets, providing a benchmark for expected performance.

9. The method of claim 8, wherein the continuous monitoring step involves real-time adjustment of algorithm parameters, switching algorithms, or incorporating new features based on real-time performance metrics.

10. The method of claim 9, wherein the aggregation involves using multiple simulators to identify the most accurate data, ensuring that only the best results are aggregated and analyzed further.

11. A system for multi-level quantum-based vertically classified entropy exploratory analytics, comprising:
a data collection module configured to collect multi-dimensional transactional data from various sources, including databases, sensors, and user interactions, to form an aggregated dataset;
a preprocessing module configured to perform data cleaning by identifying and correcting errors, inconsistencies, and missing values using imputation techniques;
normalization to scale the data to a standard range; feature engineering to create new features such as interaction terms, polynomial features, and domain-specific variables; and data integration to merge datasets from multiple sources, resolve data conflicts, and ensure consistency across different data formats, producing a preprocessed dataset;
a dimensionality reduction module configured to apply dimensionality reduction techniques, including Principal Component Analysis (PCA) to transform the data into a set of linearly uncorrelated variables called principal components, t-Distributed Stochastic Neighbor Embedding (t-SNE) to visualize high-dimensional data by converting similarities between data points into joint probabilities and minimizing divergence in a lower-dimensional space, Linear Discriminant Analysis (LDA) to project the data onto a lower-dimensional space where the classes are distinct, and Autoencoders to learn efficient encodings of the data, capturing the most important features and patterns, to the preprocessed dataset to obtain a reduced-dimensionality dataset;
an exploratory data analysis module configured to perform exploratory data analysis on the reduced-dimensionality dataset to uncover patterns, relationships, and anomalies, utilizing statistical summaries including measures of central tendency, variability, and distribution shape, and creating visualizations such as histograms to show frequency distribution, scatter plots to illustrate relationships between variables, and box plots to provide a summary of data distribution, to understand data distribution and identify relationships between variables;
a quantum encoding module configured to encode analyzed data into quantum states, leveraging principles of quantum superposition and entanglement, and employing quantum gates, including Hadamard gates for creating superposition, Pauli-X, Pauli-Y, and Pauli-Z gates for performing rotations on qubits, and CNOT (controlled-NOT) gates for entangling qubits, to transform the data into quantum-compatible format using quantum circuits;
an algorithm and feature selection module configured to dynamically select the most suitable algorithms and features for quantum-encoded data, incorporating data simulation to create synthetic datasets that mimic real data characteristics, scenario analysis to explore hypothetical situations, and adaptive selection processes to refine algorithm choices based on real-time performance metrics;
a quantum processing module configured to process the quantum-encoded data using quantum algorithms, including Shor's Algorithm for factoring large integers, Grover's Algorithm for searching unsorted databases, Quantum Approximate Optimization Algorithm (QAOA) for solving combinatorial optimization problems, and Variational Quantum Eigensolver (VQE) for finding the lowest eigenvalue of a given Hamiltonian, executed through quantum circuits with qubits and quantum gates, leveraging superposition and quantum interferences to amplify correct solutions and diminish incorrect ones;
a performance monitoring module configured to continuously monitor the performance of the selected algorithms and adapt them in real-time based on performance metrics, including accuracy, precision, recall, F1 score, and computational efficiency, to optimize their efficiency and accuracy, adjusting algorithm parameters, switching algorithms, or incorporating new features as necessary;
an aggregation module configured to aggregate results from multiple stages of algorithm execution, weighing reliability and relevance of each result, using multiple simulators to identify the most accurate data, and combining them to form a comprehensive analysis, ensuring that only the best results are aggregated and analyzed further; and
a results presentation module configured to present final analysis results in a user-friendly format, including charts, graphs, and reports, ensuring accurate and comprehensive data insights for informed decision-making.

12. The system of claim 11, wherein the preprocessing module is further configured to handle missing values using imputation techniques to fill in missing data points and the normalization in the preprocessing module involves scaling the data to a standard range, eliminating discrepancies due to different units of measurement.

13. The system of claim 12, wherein the feature engineering process in the preprocessing module includes generating interaction terms, polynomial features, and domain-specific variables to enhance predictive power of the algorithms.

14. The system of claim 13, wherein the data integration in the preprocessing module involves merging datasets from multiple sources, resolving data conflicts, and ensuring consistency across different data sources.

15. The system of claim 14, wherein the dimensionality reduction module further comprises using autoencoders to learn efficient encodings of the data, capturing the most important features and patterns.

16. The system of claim 15, wherein the exploratory data analysis module utilizes techniques such as t-SNE for visualizing high-dimensional data by converting similarities between data points into joint probabilities and minimizing the divergence between these joint probabilities in a lower-dimensional space.

17. The system of claim 16, wherein the algorithm and feature selection module includes evaluating each algorithm based on historical performance on similar datasets, providing a benchmark for expected performance.

18. The system of claim 17, wherein the performance monitoring module involves real-time adjustment of algorithm parameters, switching algorithms, or incorporating new features based on real-time performance metrics.

19. The system of claim 18, wherein the aggregation module uses multiple simulators to identify the most accurate data, ensuring that only the best results are aggregated and analyzed further.

20. A method for multi-level quantum-based vertically classified entropy exploratory analytics, comprising the steps of:
collecting multi-dimensional transactional data from various sources;
preprocessing the data as collected by performing data cleaning, normalization, feature engineering, and integration to produce a preprocessed dataset;
applying dimensionality reduction techniques to the preprocessed dataset to obtain a reduced-dimensionality dataset;
performing exploratory data analysis on the reduced-dimensionality dataset to uncover patterns, relationships, and anomalies;
encoding analyzed data into quantum states using a quantum encoder, leveraging principles of quantum superposition and entanglement;
dynamically selecting most suitable algorithms and features for quantum-encoded data using an algorithm selector and a feature selector, incorporating data simulation and scenario analysis;
processing the quantum-encoded data using quantum algorithms executed through quantum circuits with qubits and quantum gates;
continuously monitoring the performance of the selected algorithms and adapting them in real-time based on performance metrics to optimize their efficiency and accuracy; and
aggregating results from multiple stages of algorithm execution and presenting final analysis in a user-friendly format, ensuring accurate and comprehensive data insights.
